(19) United States
(12) Patent Application Publication
(10) Pub. No.: US 2012/0024572 A1
(43) Pub. Date: Feb. 2, 2012

(54) CONDUCTIVE COMPOSITION, TRANSPARENT CONDUCTOR USING THE SAME, AND TOUCH PANEL CONTAINING THE TRANSPARENT CONDUCTOR

(75) Inventors: Kenji NAOI, Kanagawa (JP); Fumio Obata, Kanagawa (JP); Yuki Matsunami, Kanagawa (JP)

(73) Assignee: FUJIFILM Corporation, Tokyo (JP)

(21) Appl. No.: 13/175,012

(22) Filed: Jul. 1, 2011

Related U.S. Application Data
(63) Continuation-in-part of application No. PCT/JP2010/073011, filed on Dec. 21, 2010.

(30) Foreign Application Priority Data
Dec. 25, 2009 (JP) 2009-294976
Feb. 23, 2010 (JP) 2010-037694

(51) Int. Cl. H01B 5/16; H01B 1/22; B82Y 99/00

(52) U.S. Cl. 174/126.1; 252/512; 977/762

(57) ABSTRACT

A conductive composition including metal nanowires having an average minor axis diameter of 5 nm to 45 nm, and a water-insoluble polymer containing at least one ethylenically unsaturated group selected from an acryloyl group and a methacryloyl group.

This is a continuation-in-part of International Application

PCT/JP2010/073011, with an international filing date of 21 Dec. 2010, which is pending.

### BACKGROUND OF THE INVENTION

1. Field of the Invention

The present invention relates to a conductive composition, a transparent conductor using the conductive composition, and a touch panel containing the transparent conductor.

2. Description of the Related Art

In recent years, there have been increased concerns about the environment. Also, as one energy measure, various attempts have been made on development of solar cells, which are about to be put into practice. The solar cells generate electricity directly from sunlight; that is, they are clean electricity-generating methods. In an attempt to improve conversion efficiency of the solar cells, absorption of lights with long wavelengths has been considered. In this case, light absorption (light transmittance) of a transparent electrode becomes important, which plays a role in extracting electrical energy from the solar cells. In general, ITO (indium tin oxide) or zinc oxide, which is used for transparent electrodes of solar cells, is doped mainly with a N-type dopant for imparting conductivity thereto. Increasing in the amount of the dopant for increasing conductivity decreases the transmittance to lights with long wavelengths. Also, an attempt to increase transmittance to light with long wavelengths decreases transparency, which is problematic.

Also in touch panels, whose demand has rapidly been expanding recently as portable game machines and the like become popular, ITO has widely been used as a transparent conductive material. However, similar to the case of the solar cells, the transmittance to lights with long wavelengths is low to be poor in color tone. In addition, as a specific problem in the touch panels, the durability to writing pressure is poor.

In order to solve such problems, for example, a transparent conductor using silver nanowires has been proposed (see U.S. Pat. Application Publication No. 2007/74316). This transparent conductor is excellent in terms of transparency, resistance, and reduction of amount of metal used.

However, in general, this transparent conductor is synthesized using an organic solvent at high temperatures. In addition, depending on the diameter of the silver nanowires used, the transparent conductor becomes high in haze and considerably low in contrast. Furthermore, so long as the uppermost surface layer exposed to air is not coated with, for example, a photocurable resin, the practical-level durability cannot be obtained. This coating decreases the resistance of the transparent conductor, degrading uniformity in surface resistance.

Also, there have been proposed conductive materials each containing a resin used for an oil ink (e.g., an acryl resin), a resin used for an aqueous ink (e.g., an aqueous acryl resin) or a hydrophilic polymer (e.g., methyl cellulose) (see Japanese Patent Application Laid-Open Nos. 2009-140788 and 2005-317394).

However, when the above conductive materials are thinly applied and used as a transparent conductor, the amount of silver in the ratio between a binder and silver is large and thus the coating liquid tends to form aggregates as time passes. The conductive film formed through coating is decreased in transparency, is often degraded in haze, and also is low in transmittance to lights with long wavelengths.

### BRIEF SUMMARY OF THE INVENTION

In view of the above, an object of the present invention is to provide: a conductive composition capable of forming a conductive layer excellent in conductivity, durability and transmittance to lights with long wavelengths; a transparent conductor using the conductive composition; and a touch panel containing the transparent conductor.

Means for solving the above existing problems are as follows.

<1> A conductive composition including:

metal nanowires having an average minor axis diameter of 5 nm to 45 nm, and

a water-insoluble polymer containing at least one ethylenically unsaturated group selected from an acryloyl group and a methacryloyl group.

<2> The conductive composition according to <1>, wherein the water-insoluble polymer contains a main chain and a side chain linked with the main chain, and the side chain contains at least one ethylenically unsaturated bond.

<3> The conductive composition according to <1> or <2>, wherein the water-insoluble polymer contains a structure represented by the following General Formula (I).

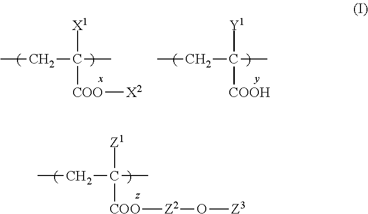

In General Formula (I), X¹, Y¹ and Z¹ each independently represent a hydrogen atom or a methyl group, X² represents an organic group having a branched structure or an alicyclic structure, Z² represents a single bond or a divalent organic group, Z³ represents an acryloyl group or a methacryloyl group, and x, y or z denotes a molar ratio of a repeating unit indicated by x, y or z and is a numerical value greater than 0 but smaller than 100, provided that a sum of x, y and z is 100.

<4> The conductive composition according to <3>, wherein X² is an isopropyl group, a t-butyl group, a cyclohexyl group, a dicyclotrimethyl group or a dicyclopentanyl group, and Z² is a 2-hydroxy-1,3-propylene group or a 2-hydroxy-1,4-cyclohexylene group.

<5> The conductive composition according to <3> or <4>, wherein x is 10 to 75, y is 5 to 70 and z is 10 to 70.

<6> The conductive composition according to any one of <1> to <5>, wherein the water-insoluble polymer has a weight average molecular weight of 10,000 to 100,000.

<7> The conductive composition according to any one of <1> to <6>, wherein the metal nanowires have an average major axis diameter of 1 μm to 40 μm.

<8> The conductive composition according to any one of <1> to <7>, wherein a ratio of A/B is 0.1 to 5 where A denotes a mass of the metal nanowires and B denotes a mass of the water-insoluble polymer.

<9> The conductive composition according to any one of <1> to <8>, further including a dispersing agent for dispersing the metal nanowires.

<10> The conductive composition according to <9>, wherein the dispersing agent is contained in an amount of 0.1 parts by mass to 50 parts by mass per 100 parts by mass of the water-insoluble polymer.

<11> A transparent conductor including:

a conductive layer containing the conductive composition according to any one of <1> to <10>.

<12> The transparent conductor according to <11>, wherein the conductive layer contains the metal nanowires at 0.005 g/m² to 0.5 g/m².

<13> A touch panel including:

the transparent conductor according to <11> or <12>.

<16> A solar cell including:

the transparent conductor according to <11> or <12>.

The present invention can provide a water-insoluble polymer-containing conductive composition excellent in conductivity, durability and transmittance to lights with long wavelengths; a transparent conductor using the conductive composition; and a touch panel containing the transparent conductor. These can solve the existing problems and achieve the above objects.

### BRIEF DESCRIPTION OF THE DRAWINGS

FIG. 1 is a schematic, cross-sectional view of one exemplary touch panel.

FIG. 2 is a schematic, explanatory view of another exemplary touch panel, where reference character D denotes a driving circuit.

FIG. 3 is a schematic, plan view of one exemplary arrangement of transparent conductors in the touch panel illustrated in FIG. 2.

FIG. 4 is a schematic, cross-sectional view of still another exemplary touch panel.

### DETAILED DESCRIPTION OF THE INVENTION

### (Conductive Composition)

A conductive composition of the present invention contains metal nanowires having an average minor axis diameter of 5 nm to 45 nm, and a water-insoluble polymer containing at least one ethylenically unsaturated group selected from an acryloyl group and a methacryloyl group; and, if necessary, further contains a dispersing agent and other ingredients.

### <Metal Nanowires>

The structure of the metal nanowires is not particularly limited and may be appropriately selected depending on the intended purpose. The structure thereof is preferably a solid structure or a hollow structure.

In the present invention, the metal nanowires used have an average minor axis diameter of 5 nm to 45 nm.

### <<Metal Nanowires>>

### Metal

The material of the metal nanowires is not particularly limited. The material is preferably at least one metal selected from the 4^{th}, 5^{th} and 6^{th} periods of the long form of Periodic Table (IUPAC 1991), more preferably at least one metal selected from the 2^{nd} to 14^{th} groups thereof, yet more preferably at least one metal selected from the 2^{nd} group, the 8^{th} group, 9^{th} group, 10^{th} group, 11^{th} group, 12^{th} group, 13^{th} group and 14^{th} group thereof. Moreover, it is particularly preferred that the above at least one metal be contained in the material as a main component.

Examples of the metal include copper, silver, gold, platinum, palladium, nickel, tin, cobalt, rhodium, iridium, iron, ruthenium, osmium, manganese, molybdenum, tungsten, niobium, tantalum, titanium, bismuth, antimony, lead and alloys thereof. Among them, silver, and alloys formed between silver and a metal(s) other than silver are particularly preferred, since they are excellent in conductivity.

The alloys formed between silver and a metal(s) other than silver are preferably alloys formed between silver and at least one metal selected from the group consisting of gold, palladium, iridium, platinum and osmium, since these alloys can give a conductive layer excellent in both conductivity and transparency.

### Shape

The shape of each of the metal nanowires is not particularly limited and may be appropriately selected depending on the intended purpose. For example, the metal nanowire may have any shape such as a cylindrical columnar shape, a rectangular parallelepiped shape, and a columnar shape with a polygonal cross-section. When high transparency is required in use, the metal nanowire preferably has a cylindrical columnar shape or a polygonal cross-section whose corners are rounded.

The shape of the cross-section of the metal nanowire may be confirmed as follows. Specifically, an aqueous dispersion of the metal nanowires is applied onto a substrate, and their cross-sections are observed under a transmission electron microscope (TEM).

Average Minor Axis Diameter and Average Major Axis Diameter In the present invention, the metal nanowires used have an average minor axis diameter of 5 nm to 45 nm (hereinafter the average minor axis diameter may be referred to as “average diameter”). Use of the metal nanowires having such an average minor axis diameter can give a conductive layer excellent in conductivity, durability and transmittance to lights with long wavelengths. The average minor axis diameter of the metal nanowires is preferably 10 nm to 40 nm, more preferably 15 nm to 35 nm.

When the average minor axis diameter thereof is less than 5 nm, the metal nanowires may be decreased in oxidation resistance and hence degraded in durability. Whereas when the average minor axis diameter thereof is more than 45 nm, scattering due to the metal nanowires occurs, resulting in that satisfactory transparency cannot be obtained in some cases.

The average minor axis diameter (average diameter) of the metal nanowires is measured with a transmission electron microscope (TEM) (product of JEOL Ltd., JEM-2000FX). Specifically, randomly selected 300 metal nanowires are measured for minor axis diameter, and the obtained values are averaged. Notably, when the cross-sectional shape of the metal nanowire in the direction along the minor axis thereof is not circular, the minor axis diameter thereof is defined as the longest diameter thereof.

The average major axis diameter of the metal nanowires (hereinafter the average major axis diameter may be referred to as “average major axis diameter”) is preferably 1 μm to 40 μm, more preferably 3 μm to 35 μm, particularly preferably 5 μm to 30 μm, since use of the metal nanowires having such an average major axis diameter can easily give a conductive layer excellent in conductivity and transparency.

The average major axis diameter of the metal nanowires is measured with a transmission electron microscope (TEM) (product of JEOL Ltd., JEM-2000FX). Specifically, randomly selected 300 metal nanowires are measured for major axis diameter, and the obtained values are averaged. Notably, when the metal nanowire is curved, the major axis diameter of the curved metal nanowire is defined as a value calculated from the radius and curvature of a circle drawn from the curved metal nanowire as an arc.

### Production Method

The production method for the metal nanowires is not particularly limited and may be any production method. Preferably, as described below, the metal nanowires are produced by reducing metal ions under heating in a solvent containing a halogen compound and a dispersing additive dissolved therein.

The solvent is preferably a hydrophilic solvent. Examples of the hydrophilic solvent include water, alcohols, ethers and ketones. These may be used alone or in combination.

Examples of the alcohols include methanol, ethanol, propanol, isopropanol, butanol and ethylene glycol.

Examples of the ethers include dioxane and tetrahydrofuran.

Examples of the ketones include acetone.

The heating temperature for the above heating is preferably 250° C. or lower, more preferably 20° C. to 200° C., yet more preferably 30° C. to 180° C., particularly preferably 40° C. to 170° C.

When the heating temperature is lower than 20° C., the formed metal nanowires become too long since the yield of core formation is lowered as the heating temperature becomes lower. Thus, these metal nanowires tend to be tangled each other, potentially leading to degradation of dispersion stability. Whereas when the heating temperature is higher than 250° C., the angles of the cross sections of the formed metal nanowires become sharp and thus, the transmittance of the coated film formed therefrom may be lowered.

If necessary, the temperature may be changed during the formation of metal nanowires. To change the temperature in the course of the formation may contribute to the control for formation of the core of the metal nanowires, to the prevention of generation of re-grown cores, and to the promotion of selective growth to improve the monodispersibility.

It is preferred that the reducing agent be added at the time of the heating.

The reducing agent is not particularly limited and may be appropriately selected from commonly-used reducing agents. Examples of the reducing agent include metal salts of boron hydrides, aluminum hydride salts, alkanol amines, aliphatic amines, heterocyclic amines, aromatic amines, aralkyl amines, alcohols, organic acids, reducing sugars, sugar alcohols, sodium sulfite, hydrazine compounds, dextrin, hydroquinones, hydroxylamines, ethylene glycol and glutathione. Among them, the reducing sugars, sugar alcohols that are derivatives of the reducing sugars, and ethylene glycol are particularly preferred.

Examples of the metal salts of boron hydrides include sodium boron hydride and potassium boron hydride.

Examples of the aluminum hydride salts include lithium aluminum hydride, potassium aluminum hydride, cesium aluminum hydride, beryllium aluminum hydride, magnesium aluminum hydride and calcium aluminum hydride.

Examples of the alkanol amines include diethylamino ethanol, ethanol amine, propanol amine, triethanol amine and dimethylamino propanol.

Examples of the aliphatic amines include propyl amine, butyl amine, dipropylene amine, ethylene diamine and triethylenepentamine.

Examples of the heterocyclic amines include piperidine, pyrrolidine, N-methylpyrrolidine and morpholine.

Examples of the aromatic amines include aniline, N-methyl aniline, toluidine, anisidine and phenetidine.

Examples of the aralkyl amines include benzyl amine, xylene diamine and N-methylbenzyl amine.

Examples of the alcohols include methanol, ethanol and 2-propanol. Examples of the organic acids include citric acid, malic acid, tartaric acid, citric acid, succinic acid and ascorbic acid.

Examples of the reducing sugars include glucose, galactose, mannose, fructose, sucrose, maltose, raffinose and stachyose.

Examples of the sugar alcohols include sorbitol.

Note that, there is a case where the reducing agents may also function as a dispersing additive or a solvent depending on the types of the reducing agents, and those reducing agents are also preferably used.

The metal nanowires are preferably produced through addition of a dispersing additive and a halogen compound or halogenated metal fine particles.

The timing when the dispersing additive and halogen compound are added may be before or after addition of the reducing agent, and may be before or after addition of the metal ions or halogenated metal fine particles. For producing nanowires having better monodispersibility, the halogen compound is preferably added twice or more times in a divided manner.

The dispersing additive is not particularly limited and may be appropriately selected depending on the intended purpose. Examples of the dispersing additive include amino group-containing compounds, thiol group-containing compounds, sulfide group-containing compounds, amino acids or derivatives thereof, peptide compounds, polysaccharides, synthetic polymers, and gels derived from those mentioned above. Among them, particularly preferred are gelatin, polyvinyl alcohol, methyl cellulose, hydroxypropyl cellulose, polyalkylene amine, partial alkyl ester of polyacrylic acid, polyvinyl pyrrolidone and polyvinyl-pyrrolidine copolymer.

The structures usable for the dispersing additive can be, for example, referred to the description in “Pigment Dictionary” (edited by Seishiro Ito, published from ASAKURA PUBLISHING CO., 2000).

Depending on the type of the dispersing additive used, the shapes of metal nanowires obtained can be changed.

The halogen compound is not particularly limited, so long as it contains bromine, chlorine or iodine, and may be appropriately selected depending on the intended purpose. Preferable examples of the halogen compound include alkali halides such as sodium bromide, sodium chloride, sodium iodide, potassium iodide, potassium bromide, potassium chloride and potassium iodide; and compounds that can be used in combination with the below-described dispersing agent.

Note that, there may be a case where the halogen compounds may also function as a dispersing agent depending on the types of the halogen compounds, and those halogen compounds are also preferably used.

Halogenated silver fine particles may be used instead of the halogen compound, or the halogen compound and the halogenated silver fine particles may be used in combination.

A single compound having the functions of both the dispersing agent and the halogen compound or halogenated silver fine particles may be used. Examples of the compound having the functions of both the dispersing agent and the halogen compound include hexadecyl-trimethylammonium bromide (HTAB) and stearyltrimethylammonium bromide, each containing an amino group and a bromide ion, and hexadecyl-trimethylammonium chloride (HTAC) containing an amino group and a chloride ion.

The demineralizing treatment can be performed after formation of the metal nanowires through, for example, ultrafiltration, dialysis, gel filtration, decantation or centrifugation. Among them, it is preferably performed through ultrafiltration. The ultrafiltration may be dead-end ultrafiltraion or cross-flow ultrafiltration. It is preferably cross-flow ultrafiltration.

The aspect ratio of the metal nanowires is not particularly limited, so long as it is 10 or more, and may be appropriately selected depending on the intended purpose. The aspect ratio of the metal nanowires is preferably 50 to 10,000, more preferably 100 to 10,000.

The metal nanowires adjusted in aspect ratio to fall within the above ranges are in properly contact with each other to form a network without being tangled and aggregated each other. Thus, they can easily give a conductive layer excellent in conductivity and transparency.

### <<Ratio of Metal Nanowires Having an Aspect Ratio of 10 or Higher>>

The ratio of the metal nanowires having an aspect ratio of 10 or higher to the total metal nanowires of the metal nanowires having an aspect ratio of 10 or higher and the metal nanowires having an aspect ratio lower than 10 (hereinafter may be referred to as “ratio of high-aspect metal nanowires”) is preferably 50% or higher on the volume basis, more preferably 60% or higher, particularly preferably 75% or higher. Here, the metal nanowires having an aspect ratio lower than 10 should be construed as encompassing metal nanowires, spherical products, cubic products, rectangular parallelepiped products, polygon products and products having other shapes.

By adjusting the ratio of the high-aspect metal nanowires to a value of 50% or higher, the metal nanowires are in properly contact with each other to form a network without being tangled and aggregated each other. Thus, they can easily give a conductive layer excellent in conductivity and also can easily give a conductive layer excellent in transparency with less plasmon absorption.

The ratio of the high-aspect metal nanowires is measured as follows, for example, in the case where the metal nanowires are silver nanowires. First, a silver nanowire dispersion liquid is filtrated to separate the silver nanowires from the other silver particles not having nanowire shape. Then, the amount of silver remaining on the filter paper and the amount of silver passing through the filter paper are respectively measured by means of ICP atomic emission spectrometer. Thereafter, the silver nanowires remaining on the filter paper are observed under a transmission electron microscope (TEM), and randomly selected 300 silver nanowires are measured for minor axis diameter and major axis diameter. From the measurement results, after confirming that the silver nanowires have an average minor axis diameter of 200 nm or less and an average major axis diameter or 1 μm or more, their distribution is examined to calculate the ratio of the high-aspect silver nanowires. Also in the case of the metal nanowires other than the silver nanowires, the ratio of the high-aspect metal nanowires is calculated in the same manner. Notably, as the filter paper, those having a pore size which is twice or more of the maximum major axis length of particles other than the metal nanowires having an average minor axis diameter of 200 nm or less and an average major axis length of 1 μm or more measured in a TEM image, and which is equal to or less than the minimum major axis length of the metal nanowires are preferably used.

<Water-Insoluble Polymer Having at Least One Ethylenically Unsaturated Group Selected from an Acryloyl Group and a Methacryloyl Group>

The water-insoluble polymer is a water-insoluble polymer having a function of a binder. Here, regarding the term “water-insoluble,” a binder dissolved in an amount of 3 g or less in 1,000 g of pure water of 25° C. is “water-insoluble.”

The water-insoluble polymer has an SP value (calculated by the Okitsu method) of 18 MPa^{1/2} to 30 MPa^{1/2}, more preferably 19 MPa^{1/2} to 28 MPa^{1/2}, still more preferably 19.5 MPa^{1/2} to 27 MPa^{1/2}.

Use of the water-insoluble polymer having an SP value falling within the above ranges produces a conductive layer having low water content and low absorption of lights of the infrared region. This conductive layer can give, for example, a solar cell with high photoelectric conversion efficiency.

Here, the SP value is calculated by the Okitsu method (Toshinao Okitsu, “Journal of the Adhesion Society of Japan” 29(3) (1993)). Specifically, the SP value is calculated using the following equation. Notably, ΔF. is a value described in literature.

SP value(δ)=ΣΔF(Molar Attraction Constants)/V(molar volume)

When a plurality of water-insoluble polymers are used, an SP value (σ) and a hydrogen bonded term (σh) of the SP value are calculated using the following equation.

$$σ or {σ}_{h} = \frac{{M}_{1} {V}_{1} {σ}_{1} + {M}_{2} {V}_{2} {σ}_{2} + {M}_{3} {V}_{3} {σ}_{3} + … MnVn σ n}{{M}_{1} {V}_{1} + {M}_{2} {V}_{2} + {M}_{3} {V}_{3} + … MnVn σ}$$

where σn denotes an SP value of a water-insoluble polymer and water or a hydrogen bonded term of the SP value, Mn denotes a molar fraction of a water-insoluble polymer and water in a mixture, Vn denotes a molar volume, and n is an integer of 2 or greater and corresponds to the types of a solvent.

The water-insoluble polymer has at least one ethylenically unsaturated group selected from an acryloyl group and a methacryloyl group (hereinafter may be referred collectively to “(meth)acryloyl group”). Such an ethylenically unsaturated group allows the water-insoluble polymer to disperse therein the metal nanowires having an average minor axis diameter of 5 nm to 45 nm to an improved extent. In addition, when these metal nanowires and the water-insoluble polymer having such an ethylenically unsaturated group are dissolved in an organic solvent (hereinafter may be referred to as “coating liquid”), the water-insoluble polymer is excellent in maintaining the metal nanowires in a dispersion state. Even when the conductive layer formed from the coating liquid is exposed to a high-temperature, high-humidity atmosphere for a long period of time, the metal nanowires are prevented from being degraded due to, for example, oxidation. Thus, the conductive layer obtained is excellent in uniformity on the entire surface, conductivity and transmittance to light with long wavelengths. Furthermore, the conductive layer obtained has an excellent adhesiveness to a substrate and is also excellent in durability to rubbing.

Preferably, the water-insoluble polymer contains a main chain and a side chain linked with the main chain, and the side chain of the water-insoluble polymer contains at least one ethylenically unsaturated bond. A plurality of the ethylenically unsaturated bonds may be contained in the side chain. Also, the ethylenically unsaturated bond may be contained in the side chain of the water-insoluble polymer together with the branched and/or alicyclic structure and/or the acid group.

The ethylenically unsaturated bond is preferably linked to the main chain of the water-insoluble polymer via a linking group containing at least one ester group (—COOH—). In this case, between the linking group and the ethylenically unsaturated bond (i.e., an acryloyl group or methacryloyl group), there may be another linking group containing an ester group formed from the carbonyl group contained in the acryloyl group or methacryloyl group.

The water-insoluble polymer includes a water-insoluble polymer represented by the following General Formula (I).

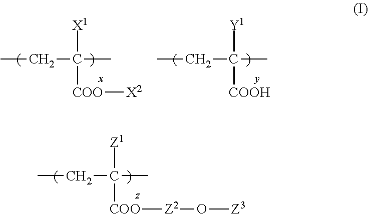

In General Formula (I), X¹, Y¹ and Z¹ each independently represent a hydrogen atom or a methyl group, X² represents an organic group having a branched structure or an alicyclic structure, Z² represents a single bond or a divalent organic group, Z³ represents an acryloyl group or a methacryloyl group, and x, y or z denotes a molar ratio of a repeating unit indicated by x, y or z and is a numerical value greater than 0 but smaller than 100, provided that a sum of x, y and z is 100.

Examples of the organic group X² having a branched structure include C3-C8 branched alkyl groups such as an i-propyl group, a s-butyl group, a t-butyl group, an i-amyl group, a t-amyl group and a 2-octyl group, with an i-propyl group, a s-butyl group and a t-butyl group being preferred.

Examples of the organic group X² having an alicyclic structure include C5-C20 alicyclic hydrocarbon groups such as a cyclopentyl group, a cyclohexyl group, a cycloheptyl group, a cyclooctyl group, a norbornyl group, an isobornyl group, an adamantyl group, a tricyclodecyl group, a dicyclopentenyl group, a dicyclopentanyl group, a tricyclopentenyl group and a tricyclopentanyl group. Each of these groups may be linked via a —CH₂CH₂O— group to the COO— in General Formula (I). Among them, preferred are a cyclohexyl group, a norbornyl group, an isobornyl group, an adamantyl group, a tricyclodecyl group, a tricyclopentenyl group, a tricyclopentanyl group, etc. More preferred are a cyclohexyl group, a norbornyl group, an isobornyl group, a tricyclopentenyl group, etc.

Examples of the divalent organic group Z² include C3-C7 alkylene groups having a hydroxy group such as a 2-hydroxy-1,3-propylene group; and C6-C9 divalent alicyclic hydrocarbon groups having a hydroxyl group such as a 2-hydroxy-1,4-cyclohexylene group.

x is preferably 10 to 75, more preferably 20 to 60, particularly preferably 25 to 55. y is preferably 7 to 50, more preferably 10 to 40. z is preferably 10 to 70, more preferably 10 to 50, particularly preferably 20 to 45.

The method for introducing the (meth)acryloyl group to the side chain of the water-insoluble polymer is not particularly limited and may be appropriately selected from known methods. Examples thereof include a method in which a compound having both an epoxy group and a (meth)acryloyl group is reacted with a polymer containing a repeating unit having an acid group so that the compound is added to the acid group, a method in which a compound having both an isocyanate group and a (meth)acryloyl group is reacted with a polymer containing a repeating unit having a hydroxyl group so that the compound is added to the hydroxyl group, and a method in which a compound having both a hydroxyl group and a (meth)acryloyl group is reacted with a polymer containing a repeating unit having an isocyanate group so that the compound is added to the isocyanate group.

Among them, particularly preferred is a method in which a compound having both an epoxy group and a (meth)acryloyl group is reacted with a polymer containing a repeating unit having an acid group so that the compound is added to the acid group, since this method can easily be performed as compared with the other methods and involves low cost.

The compound having both the epoxy group and the (meth)acryloyl group is not particularly limited, so long as it has both of these groups, and may be appropriately selected depending on the intended purpose. For example, preferred are compounds represented by the following Structural Formulas (1) and (2).

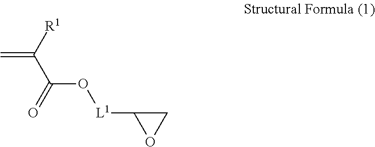

In Structural Formula (1), R¹ represents a hydrogen atom or a methyl group.

L¹ represents a divalent organic group. The organic group L¹ is preferably a hydrocarbon group, more preferably a C1-C4 hydrocarbon group. Specifically, it is preferably an alkylene group, more preferably a methylene group.

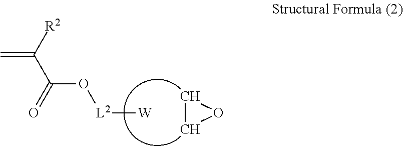

In Structural Formula (2), R² represents a hydrogen atom or a methyl group.

L² represents a divalent organic group. The organic group L² is preferably a hydrocarbon group, more preferably a C1-C4 hydrocarbon group. Specifically, it is preferably an alkylene group, more preferably a methylene group. W represents a 4 to 7-membered cyclic aliphatic hydrocarbon group. The 4 to 7-membered cyclic aliphatic hydrocarbon group is preferably a 4 to 6-membered cyclic aliphatic hydrocarbon group, more preferably a 5 or 6-membered cyclic aliphatic hydrocarbon group, particularly preferably a cyclohexane ring.

Among the compounds represented by Structural Formulas (1) and (2), preferred are the compounds represented by Structural Formula (1) from the viewpoint of being excellent in developabilitly and film strength when used as a negative photosensitive resin composition in combination with a photocurable composition.

The compounds represented by Structural Formulas (1) and (2) are not particularly limited and may be appropriately selected depending on the intended purpose. Examples thereof include the following compounds (1) to (10).

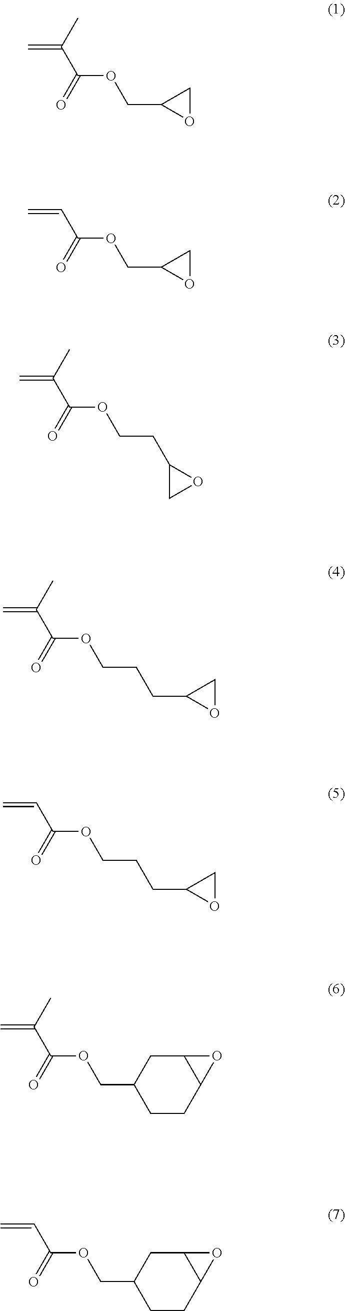

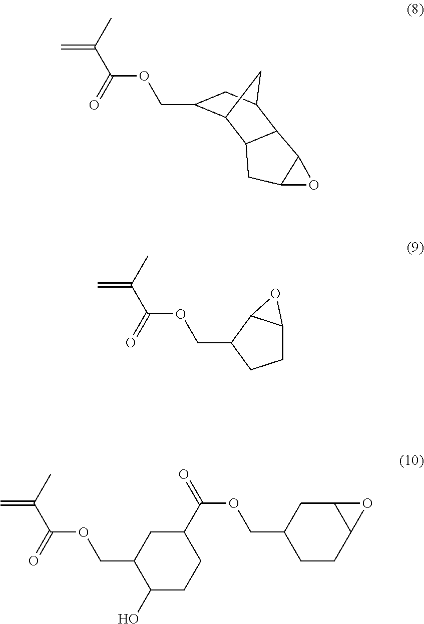

Specific examples of the water-insoluble polymer include compounds having the following structures (exemplary compounds P-1 to P-35). These exemplary compounds P-1 to P-35 each have a weight average molecular weight of 5,000 to 300,000.

Also, x, y or z described in the exemplary compounds denotes a compositional ratio (mole ratio) of a corresponding repeating unit.

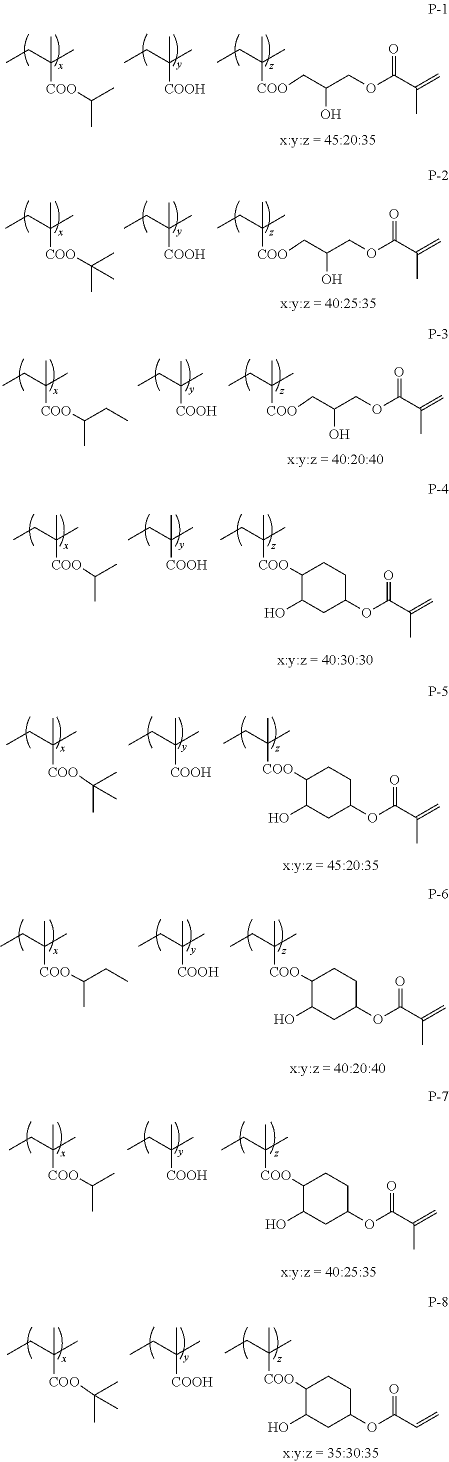

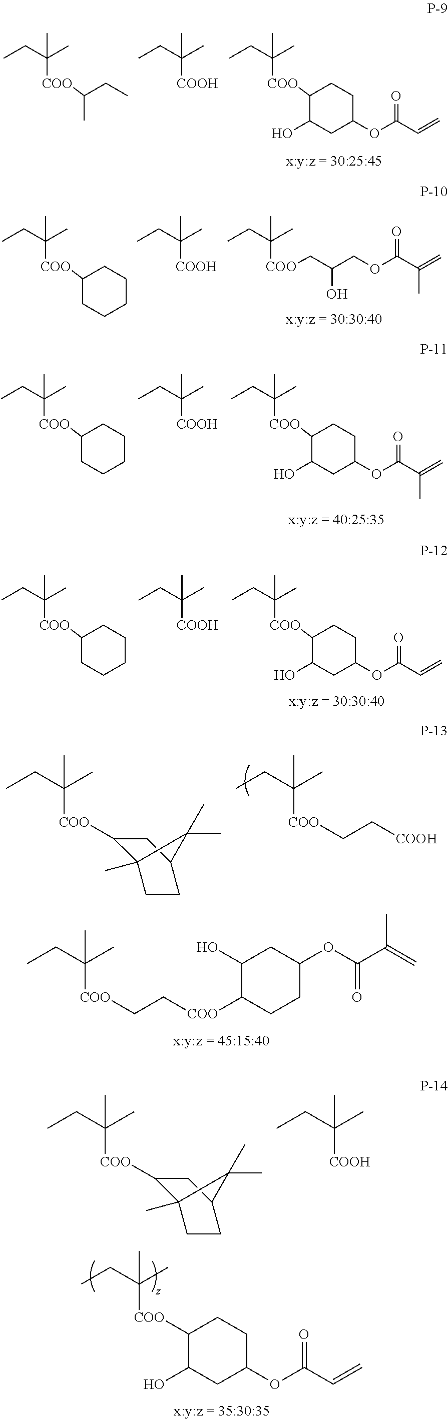

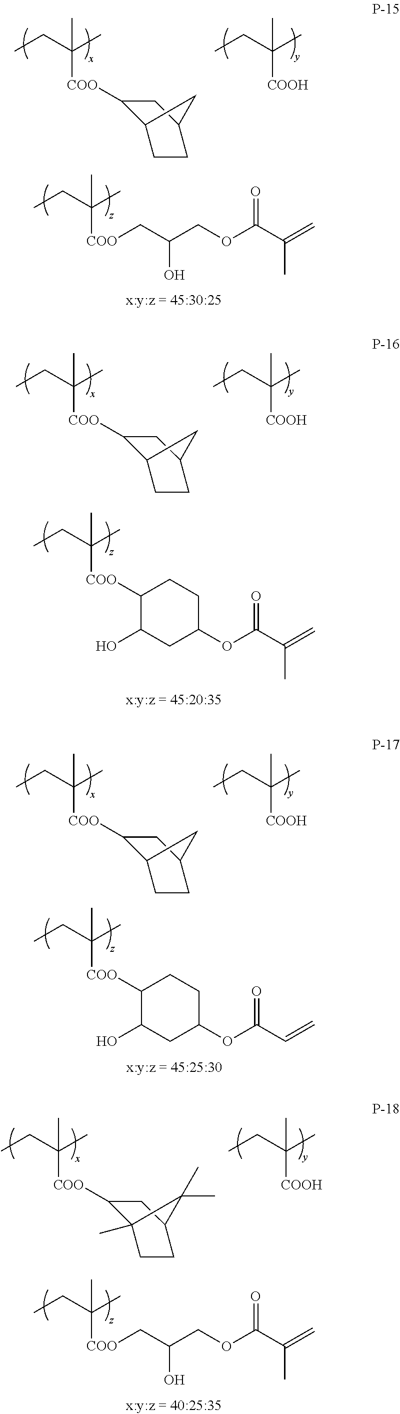

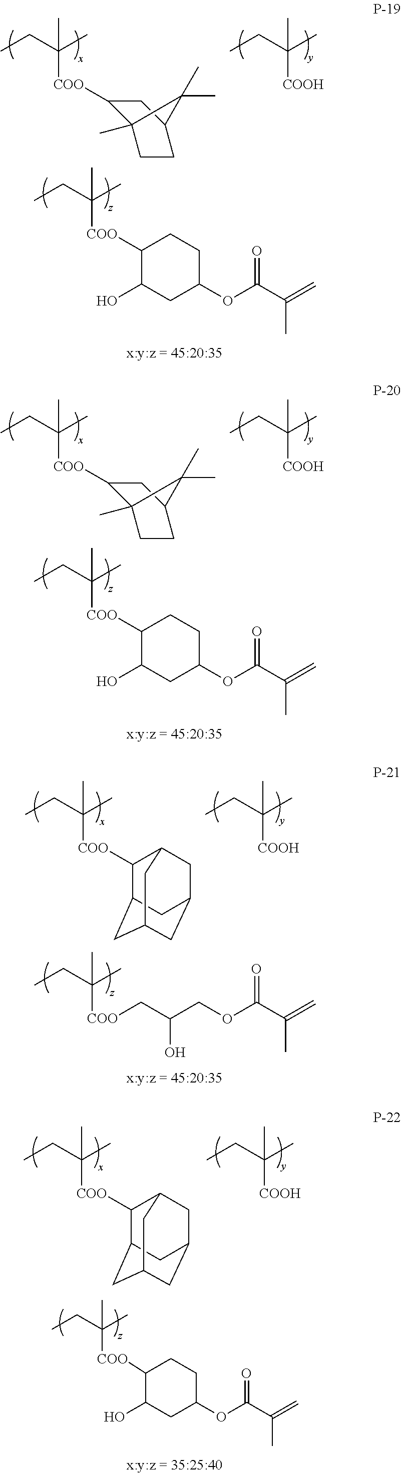

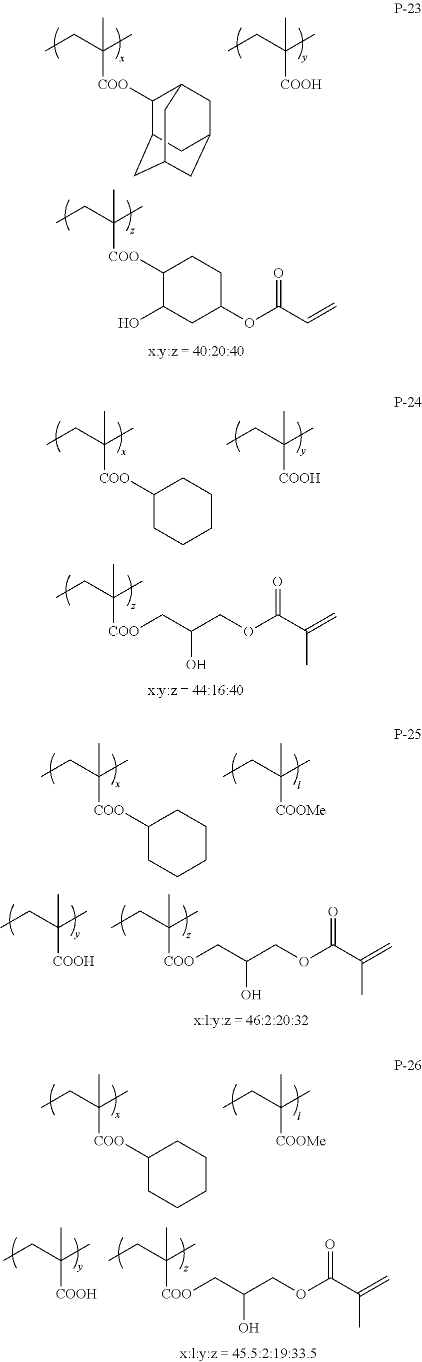

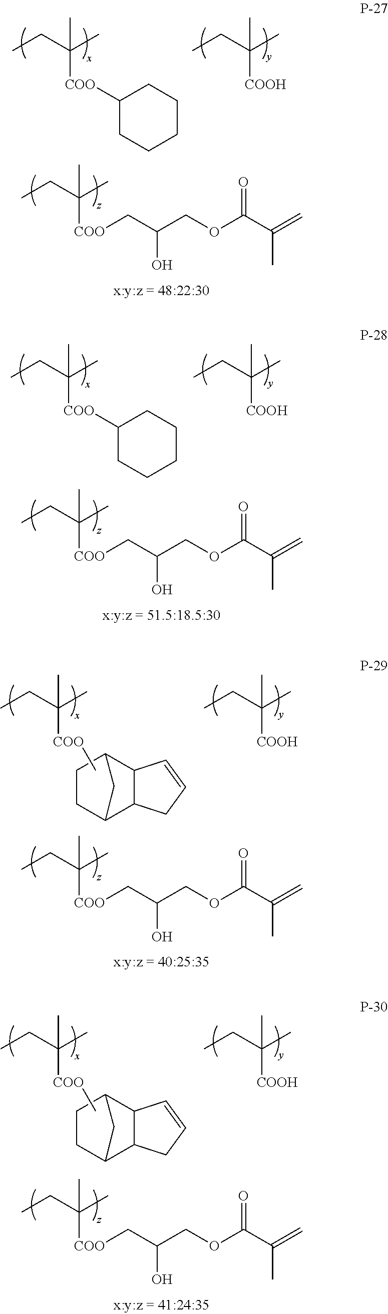

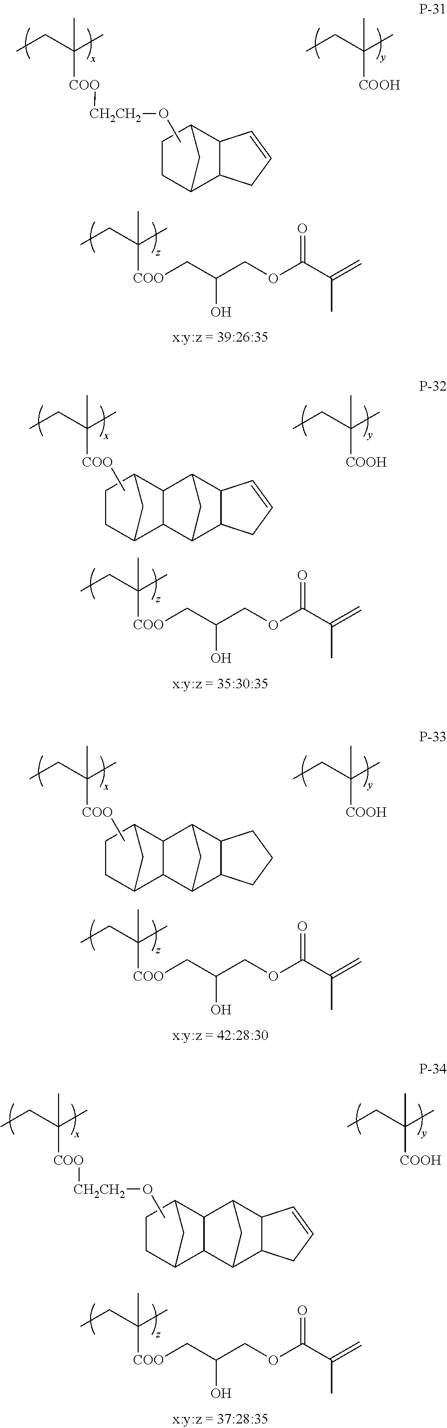

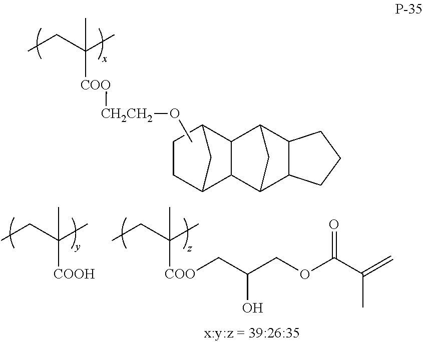

### <Synthesis Method>

The water-insoluble polymer can be synthesized through the following two steps: a step of (co)polymerizing the monomer and a step of introducing an ethylenically unsaturated group.

The (co)polymerization reaction is performed between various monomers. The (co)polymerization reaction is not particularly limited and may be appropriately selected depending on the intended purpose. Regarding the active species for polymerization, radial polymerization, cation polymerization, anion polymerization, coordination polymerization or the like may be appropriately selected. Among them, radical polymerization is preferred since it can easily be performed at low cost. Also, the method of the polymerization is not particularly limited and may be appropriately selected from known methods. For example, a bulk polymerization method, a suspension polymerization method, an emulsion polymerization method, a solution polymerization method or the like may be appropriately selected. Among them, a solution polymerization is preferred.

The weight average molecular weight of the water-insoluble polymer is preferably 10,000 to 100,000, since the water-insoluble polymer having such a weight average molecular weight is easily produced and can give a conductive layer excellent in conductivity, durability and transmittance to lights with long wavelengths. The weight average molecular weight thereof is still preferably 12,000 to 60,000, most preferably 15,000 to 45,000.

The water-insoluble polymer preferably has an acid value of 20 mgKOH/g or higher. When a negative photosensitive resin composition prepared from the conductive composition of the present invention containing the water-insoluble polymer having such an acid value is then applied onto a substrate and is then subjected to desired patternwise light exposure and development to form a conductive pattern, satisfactory developability can be maintained as well as the obtained conductive pattern becomes excellent in conductivity, durability and transmittance to lights with long wavelengths.

The acid value is more preferably 50 mgKOH/g or higher, particularly preferably 70 mgKOH/g to 130 mgKOH/g.

Regarding the ratio of the water-insoluble polymer contained, the ratio by mass (A/B) of the amount of the metal nanowires (A) and the amount of the water-insoluble polymer (B) is preferably 0.1 to 5, more preferably 0.25 to 3.5, particularly preferably 0.5 to 2.5.

By adjusting the ratio by mass (A/B) to a value of 0.1 or more, the in-plane distribution of resistances of the conductive layer becomes uniform. By adjusting the ratio by mass (A/B) to a value of 5 or less, the dispersion state of the metal nanowires in the metal nanowire dispersion liquid can be maintained stable for a long period of time.

### <Dispersing Agent>

The conductive composition may contain a dispersing agent, if necessary. The dispersing agent is used to prevent the metal nanowires from being aggregated to allow them to be homogeneously dispersed in a solvent containing the water-insoluble polymer dissolved. The dispersing agent is not particularly limited, so long as it can disperse the metal nanowires, and may be appropriately selected depending on the intended purpose. Examples thereof include commercially available low-molecular-weight pigment dispersing agents and polymeric pigment dispersing agents. Among them, preferred are polymeric dispersing agents having adsorbability onto the metal nanowires. Examples thereof include polyvinylpyrrolidone, BYK SERIES (products of BYK Chemie), SOLSPERSE SERIES (products of Nippon Lubrizol Corporation) and AJISPER SERIES (product of Ajinomoto Co., Inc.).

The amount of the dispersing agent contained is preferably 0.1 parts by mass to 50 parts by mass, more preferably 0.5 parts by mass to 40 parts by mass, particularly preferably 1 part by mass to 30 parts by mass, per 100 parts by mass of the water-insoluble polymer. When the amount of the dispersing agent falls within these ranges, the dispersing agent can disperse the metal nanowires without aggregation and good film surface can be obtained during coating.

### <Other Ingredients>

Examples of the other ingredients include various additives such as a surfactant, an antioxidant, a sulfurization inhibitor, a metal corrosion inhibitor, a viscosity adjuster and an antiseptic agent. These ingredients may appropriately be contained in the conductive composition, if necessary.

### (Transparent Conductor)

A transparent conductor of the present invention contains the above-described conductive composition. The conductive composition is preferably formed into a conductive layer on a support. Here, the transparent conductor refers, for example, to a film (interlayer conductive film) provided for attaining electrical conduction between elements arranged in the form of laminate as well as a film for ensuring in-plane electrical conduction.

The above conductive layer is a transparent conductive layer.

### <Support>

The support is not particularly limited and may be appropriately selected depending on the intended purpose. Examples thereof include transparent glass substrates, synthetic resin sheets, films, metal substrates, ceramic plates and semiconductor substrates having photoelectric conversion elements. These substrates may be pre-treated, as desired, through a chemical treatment using a silane coupling agent, a plasma treatment, ion plating, sputtering, a vapor phase reaction method, vacuum vapor deposition, etc.

Examples of the transparent glass substrates include white plate glasses, blue plate glasses and silica-coated blue glasses.

Examples of the synthetic resin sheets and films include those made of, for example, PETs, polycarbonates, polyethersulfones, polyesters, acrylic resins, vinyl chloride resins, aromatic polyamide resins, polyamideimides and polyimides.

Examples of the metal plates include aluminum plates, copper plates, nickel plates and stainless steel plates.

The support preferably has a total visible light transmittance of 70% or higher, more preferably 85% or higher, particularly preferably 90% or higher.

When the total visible light transmittance is lower than 70%, the transmittance of the support is low, which may be problematic in practical use.

Notably, in the present invention, the support may also be a colored support which is colored to such an extent that the effects of the present invention are not impeded.

The thickness of the support is preferably 1 μm to 5,000 μm, more preferably 3 μm to 4,000 μm, still more preferably 5 μm to 3,000 particularly preferably 50 μm to 300 μm, most preferably 60 μm to 200 μm.

When the thickness thereof is smaller than 1 μm, the yield may decrease due to difficulties in handling at the coating step. Whereas when the thickness thereof is greater than 5,000 μm, the thickness and mass of the support may be problematic in use for portable devices.

### <Forming Method>

### Formation of Transparent Conductor

The method for forming the transparent conductor is, for example, a method in which the conductive composition of the present invention is applied onto the support by a known method such as spin coating, roll coating or slit coating; or a method in which the conductive composition is transferred onto the support.

The transparent conductor may have a structure in which the transparent conductive layer is formed on one surface of the support by applying the above conductive composition onto the surface of the support.

Also, for example, the transparent conductor may have a structure in which two or more layers of the transparent conductive layer are formed on the support with a dielectric layer(s) being interposed therebetween.

Furthermore, the transparent conductor may have a structure in which the transparent conductive layers are formed on both surfaces of the support by applying the conductive composition onto both the surfaces of the support.

The coating amount of the metal nanowires is preferably 0.005 g/m² to 0.5 g/m², more preferably 0.01 g/m² to 0.45 g/m², particularly preferably 0.015 g/m² to 0.4 g/m². In other wards, the conductive layer preferably contains the metal nanowires at 0.005 g/m² to 0.5 g/m², more preferably contains the metal nanowires at 0.015 g/m² to 0.4 g/m².

When the coating amount of the metal nanowires is less than 0.005 g/m², the resistance becomes locally high to potentially impair the in-plane distribution of resistance. Whereas when the coating amount of the metal nanowires is more than 0.5 g/m², the metal nanowires aggregate together during drying after coating, potentially leading to degradation in haze.

The thickness of the transparent conductive layer is preferably 20 nm to 5,000 nm, more preferably 25 nm to 4,000 nm, particularly preferably 30 nm to 3,500 nm.

When the thickness of the transparent conductive layer is smaller than 20 nm, the thickness thereof is equal to the minor axis diameter of the metal nanowires in the layer to potentially degrade the film strength of the layer. Whereas when the thickness of the transparent conductive layer is greater than 5,000 nm, cracks of the film may occur and the transmittance and haze may be degraded.

If necessary, the transparent conductive layer may be subjected to patterning.

Examples of the patterning method include: a patterning method using a photocurable resin, a heat-curable resin or a negative or positive resist; an inkjet method; a printing method using screen printing, gravure printing or offset printing, a laser scribing method; and a method including forming a hydrophilic or hydrophobic pattern or an Ag-philic pattern on the support through, for example, micro contact printing and applying the silver nanowire dispersion liquid onto the support or immersing the support in the silver nanowire dispersion liquid for fixing.

Depending on the intended applications, the transparent conductor may further contain functional layers which are laminated on the transparent conductive layer(s).

Examples of the functional layer include an undercoat layer, an adhesion layer, a cushion layer, an overcoat protective layer, a protective layer, an antifouling layer, a water-repellent layer, an oil-repellent layer, a hard coat layer, a tacky layer and a barrier layer. Each of these layers may be a single layer or a plurality of layers laminated.

Also, an antiglare layer, an anti-reflection layer, a low-reflection layer, a λ/4 layer, a polarizing layer, and a phase difference layer, etc. may be laminated to impart optical functions to the transparent conductor. Each of these layers may be a single layer or a plurality of layers laminated.

### (Touch Panel)

A touch panel (or touch screen) of the present invention includes the transparent conductor containing the conductive composition of the present invention.

The touch panel is not particularly limited, so long as it contains the transparent conductor, and may be appropriately selected depending on the intended purpose. Examples of the touch panel include a surface capacitive touch panel, a projected capacitive touch panel and a resistive touch panel.

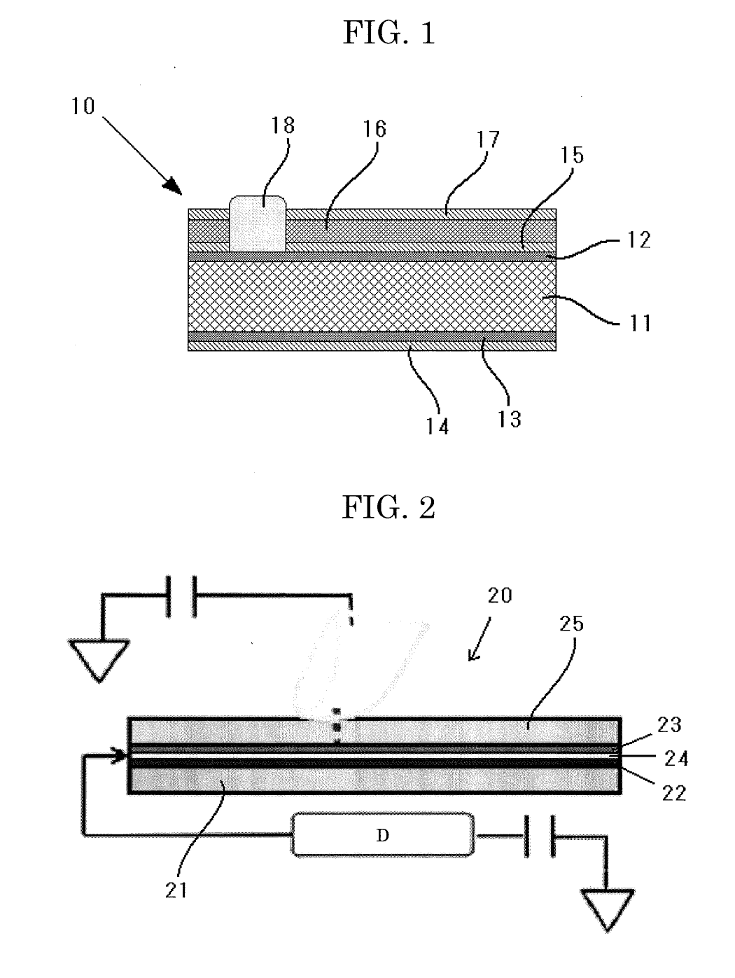

One example of the surface capacitive touch panel will be described with reference to FIG. 1. In FIG. 1, a touch panel 10 includes a transparent substrate 11, a transparent conductor 12 disposed so as to uniformly cover the surface of the transparent substrate, and an electrode terminal 18 for electrical connection with an external detection circuit, where the electrode terminal is formed on the transparent conductor 12 at the end of the transparent substrate 11.

Notably, in this figure, reference numeral 13 denotes a transparent conductor serving as a shield electrode, reference numerals 14 and 17 each denote a protective film, reference numeral 15 denotes an intermediate protective film, and reference numeral 16 denotes an antiglare layer.

For example, when touching any point on the transparent conductor 12 with a finger, the transparent conductor 12 is connected at the touched point to ground via the human body, which causes a change in resistance between the electrode terminal 18 and the grounding line. The change in resistance therebetween is detected by the external detection circuit, whereby the coordinate of the touched point is identified.

Another example of the surface capacitive touch panel will be described with reference to FIG. 2. In FIG. 2, a touch panel 20 includes a transparent substrate 21, a transparent conductor 22, a transparent conductor 23, an insulating layer 24 and an insulating cover layer 25, where the transparent conductor 22 and the transparent conductor 23 are disposed so as to cover the surface of the transparent substrate 21. The insulating layer 24 insulates the transparent conductor 22 from the transparent conductor 23. The insulating cover layer 25 creates capacitance between the transparent conductor 22 or 23 and a finger or the like coming into contact with the touch panel. In this touch panel, the position of the finger or the like coming into contact with the touch panel is detected. Depending on the intended configuration, the transparent conductors 22 and 23 may be formed as a single member and also, the insulating layer 24 or the insulating cover layer 25 may be formed as an air layer.

When touching the insulating cover layer 25 with a finger or the like, a change in capacitance is caused between the finger or the like and the transparent conductor 22 or the transparent conductor 23. The change in capacitance therebetween is detected by the external detection circuit, whereby the coordinate of the touched point is identified.

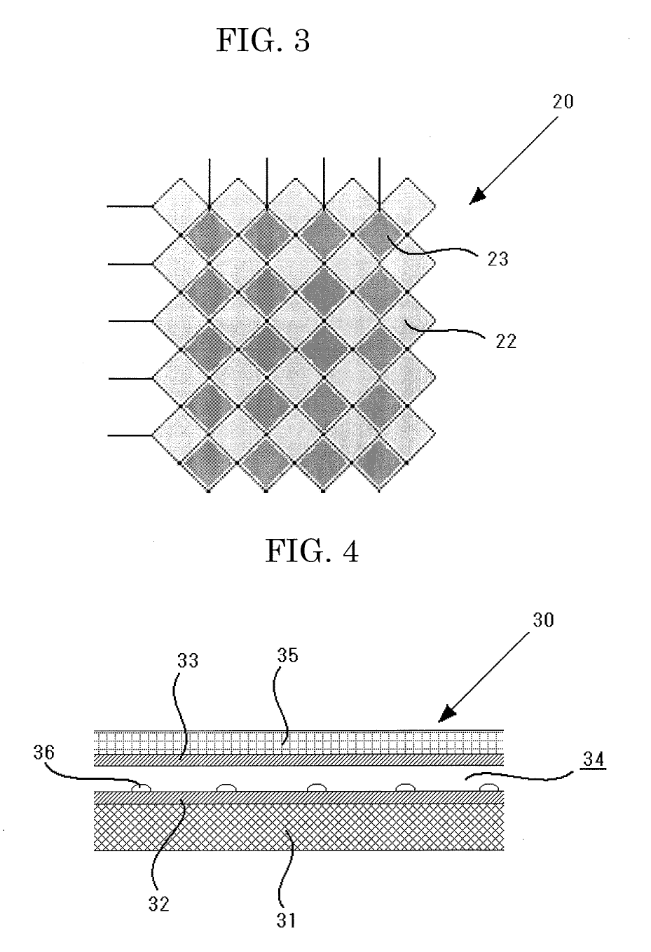

Also, a touch panel 20 as a projected capacitive touch panel will be schematically described with reference to FIG. 3 which is a plan view of the arrangement of transparent conductors 22 and transparent conductors 23.

The touch panel 20 includes a plurality of the transparent conductors 22 capable of detecting the position in the X axis direction and a plurality of the transparent conductors 23 arranged in the Y axis direction, where these transparent conductors 22 and 23 are disposed so that they can be connected with external terminals. A plurality of the transparent conductors 22 and 23 come into contact with the finger or the like, whereby contact information can be input at a plurality of points.

For example, when touching any point on the touch panel 20 with a finger, the coordinates in the X axis direction and the Y axis direction are indentified with high positional accuracy.

Notably, the other members such as a transparent substrate and a protective layer may be appropriately selected from the members of the surface capacitive touch panel. Also, the above-described pattern of the transparent conductors containing the transparent conductors 22 and 23 in the touch panel 20 is non-limiting example, and thus the shape, arrangement, etc. are not limited thereto.

One example of the resistive touch panel will be described with reference to FIG. 4. In FIG. 4, a touch panel 30 includes a transparent conductor 32, a substrate 31, a plurality of spacers 36, an air layer 34, a transparent conductor 33 and a transparent film 35, where the transparent conductor 32 is disposed on the substrate 31, the spacers 36 are disposed on the transparent conductor 32; the transparent conductor 33 can come into contact via the air layer 34 with the transparent conductor 32, and the transparent film 35 is disposed on the transparent conductor 33. These members are supported in this touch panel.

When touching the touch panel 30 from the side of the transparent film 35, the transparent film 35 is pressed and the pressed transparent conductor 32 and the pressed transparent conductor 33 come into contact with each other. A change in voltage at this point is detected with an external detection circuit, whereby the coordinate of the touched point is indentified.

### (Integrated Solar Cell)

An integrated solar cell according to the present invention contains the above-described conductive composition of the present invention.

The integrated solar cell (hereinafter may be referred to as “solar cell device”) is not particularly limited and may be the ones commonly used as a solar cell device. Examples of the integrated solar cell include a single crystal silicon solar cell device, polycrystalline silicon solar cell device, an amorphous silicon solar cell device of a single junction or tandem structure, a III-V group compound semiconductor solar cell device using, for example, gallium arsenide (GaAs) and indium phosphide (InP), a II-VI group compound semiconductor solar cell device using, for example, cadmium tellurium (CdTe), a I-III-VI group compound semiconductor solar cell device of copper/indium/selenium type (so-called, CIS type), copper/indium/gallium/selenium type (so-called, CIGS type), or copper/indium/gallium/selenium/sulfur type (so-called, CIGSS type), a dye-sensitized solar cell device, and an organic solar cell device. Among them, in the present invention, the solar cell device is preferably the amorphous silicon solar cell device of a tandem structure, and the I-III-VI group compound semiconductor solar cell device of copper/indium/selenium type (so-called, CIS type), copper/indium/gallium/selenium type (so-called, CIGS type), or copper/indium/gallium/selenium/sulfur type (so-called, CIGSS type).

In the case of the amorphous silicon solar cell device of, for example, a tandem structure, amorphous silicon, a microcrystal silicon thin layer, a thin layer formed by adding germanium to the amorphous silicon or the microcrystal silicon thin layer, or a tandem structure of two or more layers selected therefrom is used as a photoelectric conversion layer. For the formation of the layer, a plasma chemical vapor deposition (PCVD) or the like is used.

### EXAMPLES

The present invention will next be described by way of examples, which should not be construed as limiting the present invention thereto. In the following description, “part(s),” “%” and “ratio” are on the mass basis, unless otherwise specified.

### Synthesis Example 1

### Synthesis of Water-Insoluble Polymer P-1

A reaction container was charged in advance with 8.57 parts of 1-methoxy-2-propanol (MMPGAC, product of DAICEL CHEMICAL INDUSTRIES, LTD.), followed by heating to 90° C. Separately, isopropyl methacrylate (6.27 parts), methacrylic acid (5.15 parts) (serving as monomers), an azo-based polymerization initiator (product of Wako Pure Chemical Industries, Ltd., V-601) (1 part) and 1-methoxy-2-propanol (8.57 parts) were mixed together to prepare a mixed solution. Then, in a nitrogen gas atmosphere, the thus-prepared mixed solution was added dropwise to the reaction container of 90° C. for 2 hours. After completion of the dropwise addition, the resultant mixture was allowed to react for 4 hours to obtain an acryl resin solution.

Next, hydroquinone monomethyl ether (0.025 parts) and tetraethylammonium bromide (0.084 parts) were added to the thus-obtained acryl resin solution. Thereafter, glycidyl methacrylate (5.41 parts) was added dropwise to the resultant mixture for 2 hours. After completion of the dropwise addition, the resultant mixture was allowed to react at 90° C. for 4 hours while feeding air thereto. Then, 1-methoxy-2-propanol was added to the mixture so that the concentration of the solid content therein was adjusted to 45%, to thereby obtain a 45% 1-methoxy-2-propanol solution of water-insoluble polymer P-1 (acid value: 73 mgKOH/g, Mw: 10,000).

Notably, the weight average molecular weight Mw of resin P-1 was measured with gel permeation chromatograph (GPC). The SP value of the water-insoluble polymer P-1 was calculated by the Okitsu method and was found to be 21 MPa^{1/2}.

### Synthesis Example 2

### Synthesis of Water-Insoluble Polymer P-26

An acryl resin solution was prepared in the same manner as in Synthesis Example 1, except that cyclohexyl methacrylate, methyl methacrylate and methacrylic acid were used as monomers at a ratio of 45.5 mol %:2 mol %:52.5 mol %. Thereafter, a 45% 1-methoxy-2-propanol solution of water-insoluble polymer P-26 (Mw: 30,000) was obtained in the same manner as in Synthesis Example 1, except that the amount of glycidyl methacrylate was changed to an amount corresponding to 0.64 equivalent amount to the equivalent amount of carboxyl group of the acryl resin contained in the acryl resin solution. The SP value of the water-insoluble polymer P-26 was calculated by the Okitsu method and was found to be 22 MPa^{1/2}.

### Synthesis Example 3

### Synthesis of Water-Insoluble Polymer P-29

A solution of water-insoluble polymer P-29 (solid content concentration=45%) was obtained in the same manner as in Synthesis Example 1, except that dicyclopentanyl methacrylate (FA-513M, product of Hitachi Chemical Co., Ltd.) and methacrylic acid were used as monomers instead of isopropyl methacrylate and methacrylic acid and that the amounts of the monomers added were adjusted so that the molar ratio of the constituent monomers was 40:25:35, as shown in exemplary compound P-29 depicted above.

The water-insoluble polymer P-29 was found to have an acid value of 73.9 mgKOH/g and a Mw of 15,000. The SP value of the water-insoluble polymer P-29 was calculated by the Okitsu method and was found to be 22 MPa^{1/2}.

### Synthesis Example 4

### Synthesis of Water-Insoluble Polymer P-5

A solution of water-insoluble polymer P-5 (solid content concentration=45%) was obtained in the same manner as in Synthesis Example 1, except that t-butyl methacylate, methacrylic acid and 3,4-epoxycyclohexyl methacrylate (one compound represented by the above Structural Formula (2)) were used as monomers and that the amounts of the monomers added were adjusted so that the molar ratio of the constituent monomers was 45:20:35, as shown in exemplary compound P-5 depicted above.

The water-insoluble polymer P-5 was found to have an acid value of 73 mgKOH/g and a Mw of 20,000.

### Synthesis Example 5

### Synthesis of Water-Insoluble Polymer P-10

A solution of water-insoluble polymer P-10 (solid content concentration=45%) was obtained in the same manner as in Synthesis Example 1, except that cyclohexyl methacrylate, methacrylic acid and glycidyl methacrylate were used as monomers and that the amounts of the monomers added were adjusted so that the molar ratio of the constituent monomers was 30:30:40, as shown in exemplary compound P-10 depicted above.

The water-insoluble polymer P-10 was found to have an acid value of 74.2 mgKOH/g and a Mw of 17,000.

### Synthesis Example 6

### Synthesis of Water-Insoluble Polymer P-12

A solution of water-insoluble polymer P-12 (solid content concentration=45%) was obtained in the same manner as in Synthesis Example 1, except that cyclohexyl methacrylate, methacrylic acid and 3,4-epoxycyclohexyl acrylate (one compound represented by the above Structural Formula (2)) were used as monomers and the amounts of the monomers added were adjusted so that the molar ratio of the constituent monomers was 30:30:40, as shown in exemplary compound P-12 depicted above.

The water-insoluble polymer P-12 was found to have an acid value of 74 mgKOH/g and a Mw of 18,000.

### Synthesis Example 7

### Synthesis of Water-Insoluble Polymer P-18

A solution of water-insoluble polymer P-18 (solid content concentration=45%) was obtained in the same manner as in Synthesis Example 1, except that dicyclotrimethyl methacrylate, methacrylic acid and glycidyl methacrylate were used as monomers and that the amounts of the monomers added were adjusted so that the molar ratio of the constituent monomers was 40:25:35, as shown in exemplary compound P-18 depicted above.

The water-insoluble polymer P-18 was found to have an acid value of 73 mgKOH/g and a Mw of 19,000.

### Synthesis Example 8

### Synthesis of Water-Insoluble Polymer P-20

A solution of water-insoluble polymer P-20 (solid content concentration=45%) was obtained in the same manner as in Synthesis Example 1, except that dicyclotrimethyl methacrylate, methacrylic acid and 3,4-epoxycyclohexyl methacrylate (one compound represented by the above Structural Formula (2)) were used as monomers and that the amounts of the monomers added were adjusted so that the molar ratio of the constituent monomers was 40:30:30, as shown in exemplary compound P-20 depicted above.

The water-insoluble polymer P-20 was found to have an acid value of 74.2 mgKOH/g and a Mw of 21,000.

### Preparation Example 1

### Preparation of Silver Nanowire Dispersion (1)

Silver nitrate powder (0.51 g) was dissolved in pure water (50 mL) to prepare a silver nitrate solution. Then, 1N aqueous ammonia was added thereto until the silver nitrate solution became transparent. In addition, pure water was added to the resultant solution so that the total amount was adjusted to 100 mL, whereby solution A was prepared.

Separately, glucose powder (0.5 g) was dissolved in pure water (140 mL) to prepare solution B.

Furthermore, HTAB (hexadecyl-trimethylammonium bromide) powder (0.5 g) was dissolved in pure water (27.5 mL) to prepare solution C.

Solution A (20.6 mL) was added to a three-neck flask and stirred at room temperature. Then, pure water (41 mL), solution C (20.6 mL) and solution B (16.5 mL) were added thereto in this order using a funnel. The resultant mixture was heated at 90° C. for 5 hours under stirring at 200 rpm to obtain silver nanowire aqueous dispersion (1).

The thus-obtained silver nanowire aqueous dispersion (1) was cooled and then centrifuged. The resultant dispersion was purified until the conductivity thereof reached a value of 50 μS/cm or lower. SOLSPERSE 24000 (product of Nippon Lubrizol Corporation) serving as a dispersing agent was added to the dispersion in an amount of 2% by mass with respect to the amount of the silver. The resultant dispersion was further centrifuged using propylene glycol monomethyl ether to remove water. Finally, propylene glycol monomethyl ether acetate was added thereto to obtain silver nanowire dispersion (1).

The obtained silver nanowires (1) were measured as follows for average minor axis diameter, average major axis diameter, variation coefficient of minor axis diameters, and ratio of high-aspect silver nanowires (i.e., ratio of silver nanowires having an aspect ratio of 10 or higher). The results are shown in Table 1.

### Preparation Example 2

### Preparation of Silver Nanowire Dispersion (2)

Ethylene glycol (30 mL) was added to a three-neck flask and heated to 160° C. Then, an ethylene glycol solution (18 mL) containing 36 mM polyvinylpyrrolidone (PVP; K-55), 3 μM iron acetylacetonate, 60 μM sodium chloride and an ethylene glycol solution (18 mL) containing 24 mM silver nitrate were added thereto at 1 mL/min. The resultant mixture was heated at 160° C. for 60 min and then cooled to room temperature. Thereafter, water was added thereto, followed by centrifugation. The mixture was purified until the conductivity reached a value of 50 μS/cm or lower, to thereby obtain silver nanowire aqueous dispersion (2).

After centrifugation of the obtained silver nanowire aqueous dispersion (2), water was removed through decantation. SOLSPERSE 24000 (product of Nippon Lubrizol Corporation) serving as a dispersing agent was added to the dispersion in an amount of 2% by mass with respect to the amount of the silver. The resultant dispersion was further centrifuged using propylene glycol monomethyl ether to remove water. Finally, propylene glycol monomethyl ether acetate was added thereto to obtain silver nanowire dispersion (2).

In the same manner as in Preparation Example 1, the obtained silver nanowires (2) were measured for average minor axis diameter, average major axis diameter, variation coefficient of minor axis diameters, and ratio of high-aspect silver nanowires. The results are shown in Table 1.

### Preparation Example 3

### Preparation of Silver Nanowire Dispersion (3)

A silver nanowire dispersion (3) was obtained in the same manner as in Preparation Example 1, except that hexadecy-trimethylammonium bromide was changed to stearyltrimethylammonium bromide. The silver nanowires contained in the obtained silver nanowire dispersion (3) were found to be wires having an average minor axis diameter of 14 nm and an average major axis diameter of 32

In the same manner as in Preparation Example 1, the obtained silver nanowire dispersion (3) was measured for average minor axis diameter, average major axis diameter, variation coefficient of minor axis diameters, and ratio of high-aspect silver nanowires. The results are shown in Table 1.

### Preparation Example 4

### Preparation of Silver Nanowire Dispersion (4)

A silver nanowire dispersion (4) was obtained in the same manner as in Preparation Example 1, except that cyclohexanol (6.9 mL) was added in advance to the three-neck flask. The silver nanowires contained in the obtained silver nanowire dispersion (4) were found to be wires having an average minor axis diameter of 42 nm and an average major axis diameter of 29 μm.

In the same manner as in Preparation Example 1, the obtained silver nanowire dispersion (4) was measured for average minor axis diameter, average major axis diameter, variation coefficient of minor axis diameters, and ratio of high-aspect silver nanowires. The results are shown in Table 1.

### Preparation Example 5

A silver nanowire dispersion (5) was obtained in the same manner as in Preparation Example 1, except that cyclohexanol (10.4 mL) was added in advance to the three-neck flask. The silver nanowires contained in the obtained silver nanowire dispersion (5) were found to be wires having an average minor axis diameter of 52 nm and an average major axis diameter of 24 μm.

In the same manner as in Preparation Example 1, the obtained silver nanowire dispersion (5) was measured for average minor axis diameter, average major axis diameter, variation coefficient of minor axis diameters, and ratio of high-aspect silver nanowires. The results are shown in Table 1.

### <Average Minor Axis Diameter (Diameter) and Average Major Axis Diameter of Silver Nanowires>

Three hundred silver nanowires were observed under a transmission electron microscope (TEM) (product of JEOL Ltd., JEM-2000FX). Based on the average values obtained from the observation, the average minor axis diameter and the average major axis diameter of the silver nanowires were obtained.

### <Variation Coefficient of Minor Axis Diameters of Silver Nanowires>

Three hundred silver nanowires were observed for their minor axis diameters under a transmission electron microscope (TEM) (product of JEOL Ltd., JEM-2000FX). Based on the average value obtained from the observation, the minor axis diameters of the silver nanowires were calculated. The variation coefficient of the minor axis diameters was calculated from the standard deviation and the average value thereof.

### <Ratio of Metal Nanowires Having an Aspect Ratio of 10 or Higher>

Each of the silver nanowire aqueous dispersions was filtrated to separate the silver nanowires from the other silver particles not having nanowire shape, and the amount of silver remaining on the filter and the amount of silver having passed through the filter were respectively measured by means of ICP ATOMIC EMISSION SPECTROMETER (product of Shimadzu Corporation, ICPS-8000), to thereby obtain the amount of the silver nanowires having an average minor axis diameter of 45 nm or less and an average major axis diameter of 5 μm or more as the ratio (%) of the silver (metal) nanowires having an aspect ratio of 10 or more.

Note that, a membrane filter (product of Millipore K. K., FALP 02500, pore size: 1.0 μm) was used for the filtration performed for obtaining the above ratio of the silver (metal) nanowires.

TABLE 1

| | Average | Average | | Ratio of |
|---|---|---|---|---|
| | minor axis | major axis | Variation | high-aspect |
| | diameter | diameter | coefficient | silver |
| | (nm) | (μm) | (%) | nanowires (%) |
| Silver nanowires (1) | 27 | 14 | 84.3 | 78.3 |
| Silver nanowires (2) | 110 | 32 | 86.1 | 75.6 |
| Silver nanowires (3) | 14 | 32 | 81.4 | 72.4 |
| Silver nanowires (4) | 42 | 29 | 82.5 | 73.4 |
| Silver nanowires (5) | 52 | 24 | 81.1 | 71.5 |

### Example 1

### Production of Transparent Conductor 1 (Using Water-Insoluble Polymer P-26)

The silver nanowire dispersion (1) and the water-insoluble polymer P-26 were mixed together at a mixing ratio of 1/2 (silver nanowire/water-insoluble polymer), to prepare conductive composition 1. The amount of the silver nanowires contained in the thus-prepared conductive composition 1 was measured with ICP (Inductively Coupled Plasma, product of Shimadzu Corporation, ICPS-10001V) and was found to be 0.27%.

The conductive composition 1 was applied with a doctor coater onto a surface of a commercially available heat-treated biaxially drawn polyethylene terephthalate (PET) support having a thickness of 100 μm so as to have an average thickness of 15 μm, followed by drying at 25° C. and 55% RH, to thereby produce transparent conductor 1. The amount of the silver nanowires contained therein was measured with an X-ray fluorescence spectrometer (product of SII Inc., SEA1100) and was found to be 0.04 g/m².

### Example 2

### Production of Transparent Conductor 2 (Using Water-Insoluble Polymer P-26)

The procedure of Example 1 was repeated, except that the mixing ratio between the silver nanowire dispersion (1) and the water-insoluble polymer P-26 was changed from 1/2 to 1/5 (silver nanowires/water-insoluble polymer), to thereby produce conductive composition 2 and transparent conductor 2. Notably, the amount of the silver nanowires contained in the conductive composition 2 was measured with ICP (Inductively Coupled Plasma, product of Shimadzu Corporation, ICPS-10001V) and was found to be 0.27%. The amount of the silver nanowires contained in the transparent conductor 2 was measured with an X-ray fluorescence spectrometer (product of SII Inc., SEA1100) and was found to be 0.04 g/m².

### Example 3

### Production of Transparent Conductor 3 (Using Water-Insoluble Polymer P-1)

The procedure of Example 1 was repeated, except that the water-insoluble polymer P-26 was changed to the water-insoluble polymer P-1, to thereby produce conductive composition 3 and transparent conductor 3. Notably, the amount of the silver nanowires contained in the conductive composition 3 was measured with ICP (Inductively Coupled Plasma, product of Shimadzu Corporation, ICPS-10001V) and was found to be 0.27%. The amount of the silver nanowires contained in the transparent conductor 3 was measured with an X-ray fluorescence spectrometer (product of SII Inc., SEA1100) and was found to be 0.04 g/m².

### Example 4

### Production of Transparent Conductor 4 (Using Water-Insoluble Polymer P-29)

The procedure of Example 1 was repeated, except that the water-insoluble polymer P-26 was changed to the water-insoluble polymer P-29, to thereby produce conductive composition 4 and transparent conductor 4. Notably, the amount of the silver nanowires contained in the conductive composition 4 was measured with ICP (Inductively Coupled Plasma, product of Shimadzu Corporation, ICPS-10001V) and was found to be 0.27%. The amount of the silver nanowires contained in the transparent conductor 4 was measured with an X-ray fluorescence spectrometer (product of SII Inc., SEA1100) and was found to be 0.04 g/m².

### Example 5

### Production of Transparent Conductor 5 (Using Water-Insoluble Polymer P-26)

The procedure of Example 1 was repeated, except that the dispersing agent was changed from SOLSPERSE 24000 to polyvinylpyrrolidone K-30 (product of Wako Pure Chemical Industries, Ltd.) and that the propylene glycol monomethyl ether acetate was changed to propylene glycol monomethyl ether, to thereby produce conductive composition 5 and transparent conductor 5. Notably, the amount of the silver nanowires contained in the conductive composition 5 was measured with ICP (Inductively Coupled Plasma, product of Shimadzu Corporation, ICPS-10001V) and was found to be 0.27%. The amount of the silver nanowires contained in the transparent conductor 5 was measured with an X-ray fluorescence spectrometer (product of SII Inc., SEA1100) and was found to be 0.04 g/m².

### Example 6

### Production of Transparent Conductor 6 (Using Water-Insoluble Polymer P-26)

The procedure of Example 1 was repeated, except that the silver nanowire dispersion (1) was changed to the silver nanowire dispersion (3), to thereby produce conductive composition 6 and transparent conductor 6. Notably, the amount of the silver nanowires contained in the conductive composition 6 was measured with ICP (Inductively Coupled Plasma, product of Shimadzu Corporation, ICPS-10001V) and was found to be 0.27%. The amount of the silver nanowires contained in the transparent conductor 6 was measured with an X-ray fluorescence spectrometer (product of SII Inc., SEA1100) and was found to be 0.04 g/m².

### Example 7

### Production of Transparent Conductor 7 (Using Water-Insoluble Polymer P-26)

The procedure of Example 1 was repeated, except that the silver nanowire dispersion (1) was changed to the silver nanowire dispersion (4), to thereby produce conductive composition 7 and transparent conductor 7. Notably, the amount of the silver nanowires contained in the conductive composition 7 was measured with ICP (Inductively Coupled Plasma, product of Shimadzu Corporation, ICPS-10001V) and was found to be 0.27%. The amount of the silver nanowires contained in the transparent conductor 8 was measured with an X-ray fluorescence spectrometer (product of SII Inc., SEA1100) and was found to be 0.04 g/m².

### Examples 8 to 12

### Production of Transparent Conductors 8 to 12

The procedure of Example 1 was repeated, except that the water-insoluble polymer P-26 was changed to each of the water-insoluble polymers P-5, P-10, P-12, P-18 and P-20, to thereby produce conductive compositions 8 to 12 and transparent conductors 8 to 12. Notably, the amount of the silver nanowires contained in each of the conductive compositions was measured with ICP (Inductively Coupled Plasma, product of Shimadzu Corporation, ICPS-10001V) and was found to be 0.27%. The amount of the silver nanowires contained in each of the transparent conductors was measured with an X-ray fluorescence spectrometer (product of SII Inc., SEA1100) and was found to be 0.04 g/m².

### Comparative Example 1

### Production of Transparent Conductor a (Using Water-Insoluble Polymer P-26)

The procedure of Example 1 was repeated, except that the silver nanowire dispersion (1) was changed to the silver nanowire dispersion (5), to thereby produce conductive composition A and transparent conductor A. Notably, the amount of the silver nanowires contained in the conductive composition A was measured with ICP (Inductively Coupled Plasma, product of Shimadzu Corporation, ICPS-10001V) and was found to be 0.27%. The amount of the silver nanowires contained in the transparent conductor A was measured with an X-ray fluorescence spectrometer (product of SII Inc., SEA1100) and was found to be 0.04 g/m².

### Comparative Example 2

### Production of Transparent Conductor B (Using Water-Insoluble Polymer P-26)

The procedure of Example 1 was repeated, except that the silver nanowire dispersion (1) was changed to the silver nanowire dispersion (2), to thereby produce conductive composition B and transparent conductor B. Notably, the amount of the silver nanowires contained in the conductive composition B was measured with ICP (Inductively Coupled Plasma, product of Shimadzu Corporation, ICPS-10001V) and was found to be 0.27%. The amount of the silver nanowires contained in the transparent conductor B was measured with an X-ray fluorescence spectrometer (product of SII Inc., SEA1100) and was found to be 0.04 g/m².

### Comparative Example 3

### Production of Transparent Conductor C (Using Water-Insoluble Polymer P-26)

The procedure of Example 2 was repeated, except that the silver nanowire dispersion (1) was changed to the silver nanowire dispersion (2), to thereby produce conductive composition C and transparent conductor C. Notably, the amount of the silver nanowires contained in the conductive composition C was measured with ICP (Inductively Coupled Plasma, product of Shimadzu Corporation, ICPS-10001V) and was found to be 0.27%. The amount of the silver nanowires contained in the transparent conductor C was measured with an X-ray fluorescence spectrometer (product of SII Inc., SEA1100) and was found to be 0.04 g/m².

### Comparative Example 4

### Production of Transparent Conductor D (Using Water-Soluble Polymer)

The procedure of Example 1 was repeated, except that the water-insoluble polymer P-26 was changed to polyvinylpyrrolidone (PVP; K-30, product of Wako Pure Chemical Industries, Ltd., SP value: 31.5 MPa^{1/2}) (water-soluble polymer), that the silver nanowire dispersion (1) was changed to the silver nanowire dispersion (2) and that the propylene glycol monomethyl ether acetate was changed to propylene glycol monomethyl ether, to thereby produce conductive composition D and transparent conductor D. Notably, the amount of the silver nanowires contained in the conductive composition D was measured with ICP (Inductively Coupled Plasma, product of Shimadzu Corporation, ICPS-10001V) and was found to be 0.27%. The amount of the silver nanowires contained in the transparent conductor D was measured with an X-ray fluorescence spectrometer (product of SII Inc., SEA1100) and was found to be 0.04 g/m².

### Comparative Example 5

### Production of Transparent Conductor E (Using a Water-Soluble Polymer)

The procedure of Comparative Example 4 was repeated, except that the silver nanowire dispersion (2) was changed to the silver nanowire dispersion (1), to thereby produce conductive composition E and transparent conductor E. Notably, the amount of the silver nanowires contained in the conductive composition E was measured with ICP (Inductively Coupled Plasma, product of Shimadzu Corporation, ICPS-10001V) and was found to be 0.27%. The amount of the silver nanowires contained in the transparent conductor E was measured with an X-ray fluorescence spectrometer (product of SII Inc., SEA1100) and was found to be 0.04 g/m².

### Comparative Example 6

### Production of Transparent Conductor F (Using a Water-Soluble Polymer)

The procedure of Comparative Example 5 was repeated, except that the mixing ratio of the silver nanowire dispersion (1) to the polyvinylpyrrolidone (PVP) (water-soluble polymer) was changed from 1/2 to 1/5 (silver nanowire/PVP), to thereby produce conductive composition F and transparent conductor F. Notably, the amount of the silver nanowires contained in the conductive composition F was measured with ICP (Inductively Coupled Plasma, product of Shimadzu Corporation, ICPS-10001V) and was found to be 0.27%. The amount of the silver nanowires contained in the transparent conductor F was measured with an X-ray fluorescence spectrometer (product of SII Inc., SEA1100) and was found to be 0.04 g/m².

### Comparative Example 7

### Production of Transparent Conductor G

The procedure of Example 1 was repeated, except that the water-insoluble polymer P-26 was changed to polyisobutylene (product of Wako Pure Chemical Industries, Ltd., SP value: 15.8 MPa^{1/2}) and that half of the volume of the coating solvent was replaced with THF (tetrahydrofuran, product of Wako Pure Chemical Industries, Ltd.), to thereby produce conductive composition G and transparent conductor G. Notably, the amount of the silver nanowires contained in the conductive composition G was measured with ICP (Inductively Coupled Plasma, product of Shimadzu Corporation, ICPS-10001V) and was found to be 0.27%. The amount of the silver nanowires contained in the transparent conductor G was measured with an X-ray fluorescence spectrometer (product of SII Inc., SEA1100) and was found to be 0.04 g/m².

### Comparative Example 8

### Production of Transparent Conductor H

The procedure of Example 0.1 was repeated, except that the water-insoluble polymer P-26 was changed to a photocurable composition having the following composition, to thereby produce conductive composition H. The conductive composition H was applied with a doctor coater onto a surface of a commercially available heat-treated biaxially drawn polyethylene terephthalate (PET) support having a thickness of 100 μm so as to have an average thickness of 15 μm, followed by drying at 25° C. and 55% RH. In addition, the coated film was irradiated with UV rays for curing to thereby produce transparent conductor H. Notably, the amount of the silver nanowires contained in the conductive composition H was measured with ICP (Inductively Coupled Plasma, product of Shimadzu Corporation, ICPS-10001V) and was found to be 0.27%. The amount of the silver nanowires contained in the transparent conductor H was measured with an X-ray fluorescence spectrometer (product of SII Inc., SEA1100) and was found to be 0.04 g/m².

Photocurable composition:
Tripropylene glycol diacrylate: 73.1 parts
Phosphoric acid trimethylol triacrylate: 22.0 parts
Photoinitiator (Irgacure 745, product of Ciba Inc.): 4.9 parts
Antioxidant (4-methoxyphenol): 0.03 parts

Each of the transparent conductors produced in Examples 1 to 12 and Comparative Examples 1 to 8 was evaluated for conductivity, transmittance, haze, durability and flexibility in the following manner. The results are shown in Table 2.

### <Conductivity of Transparent Conductor>

The conductivity of each transparent conductor was measured by measuring the surface resistance (Ω/sq.) with Loresta-GP MCP-T600 (product of Mitsubishi Chemical Corporation).

### <Light Transmittance of Transparent Conductor>

The light transmittance of each transparent conductor was measured with respect to lights having wavelengths of 450 nm and 800 nm using a spectrophotometer (UV2400-PC, product of Shimadzu Corporation) with air being used as a reference.

### <Haze of Transparent Conductor>

The haze of each transparent conductor was measured using a haze-gard plus (product of GUARDNER Corporation).

### <Durability of Transparent Conductor to Heat and Humidity Over Time>

To evaluate durability, each transparent conductor was subjected to a test for durability to heat and humidity over time. Specifically, the transparent conductor was maintained at 80° C. and 85% RH for 250 hours and then was measured for surface resistance (Ω/sq.) with Loresta-GP MCP-T600 (product of Mitsubishi Chemical Corporation). The obtained measurement was evaluated as follows.

R1(resistance after test)/R0(resistance before test)×100=Change in resistance(%)

### Evaluation Criteria

1: Change in resistance was 300% or more; problematic level in practical use
2: Change in resistance was less than 300% and 200% or more; problematic level in practical use
3: Change in resistance was less than 200% and 150% or more; problematic level in practical use
4: Change in resistance was less than 150% and 110% or more; non-problematic level in practical use
5: Change in resistance was less than 110%; non-problematic level in practical use

### <Flexibility of Transparent Conductor>

Each of the above-obtained samples was wound around a metal rod having a diameter of 9 mm with the conductive layer facing outward, followed by being left to stand still for 15 sec. Before or after being wound around the metal rod, the sample was measured for surface resistance with Loresta-GP MCP-T600 (product of Mitsubishi Chemical Corporation). The change in surface resistance of the sample was calculated from the following: (after winding)/(before winding)×100%=change in resistance (%). The change in resistance was evaluated according to the following criteria. Notably, the greater the rank, the more excellent the flexibility.

### Evaluation Criteria

1: Change in resistance was 300% or more; problematic level in practical use
2: Change in resistance was less than 300% and 150% or more; problematic level in practical use
3: Change in resistance was less than 150% and 130% or more; non-problematic level in practical use
4: Change in resistance was less than 130% and 115% or more; non-problematic level in practical use
5: Change in resistance was less than 115%; non-problematic level in practical use

TABLE 2

| | Average minor | | | | | | | | |
|---|---|---|---|---|---|---|---|---|---|
| | axis diameter | Ratio of | Type of | Conductivity | Transmittance | Transmittance | Haze | | |
| | (nm) | amounts | binder | (Ω/sq.) | 450 nm (%) | 800 nm (%) | (%) | Durability | Flexibility |
| Ex. 1 | 27 | 1/2 | WIP | 54 | 91 | 92 | 2.0 | 4 | 4 |
| | | | P-26 | | | | | | |
| Ex. 2 | 27 | 1/5 | WIP | 87 | 91 | 92 | 1.9 | 5 | 5 |
| | | | P-26 | | | | | | |
| Ex. 3 | 27 | 1/2 | WIP | 60 | 90 | 92 | 2.1 | 4 | 4 |
| | | | P-1 | | | | | | |
| Ex. 4 | 27 | 1/2 | WIP | 57 | 91 | 92 | 2.0 | 4 | 4 |
| | | | P-29 | | | | | | |
| Ex. 5 | 27 | 1/2 | WIP | 62 | 90 | 89 | 2.0 | 4 | 5 |
| | | | P-26 | | | | | | |
| Ex. 6 | 14 | 1/2 | WIP | 71 | 90 | 89 | 1.8 | 4 | 4 |
| | | | P-26 | | | | | | |
| Ex. 7 | 42 | 1/2 | WIP | 66 | 87 | 86 | 4.4 | 4 | 4 |
| | | | P-26 | | | | | | |
| Ex. 8 | 27 | 1/2 | WIP | 66 | 90 | 92 | 2.1 | 4 | 4 |
| | | | P-5 | | | | | | |
| Ex. 9 | 27 | 1/2 | WIP | 67 | 90 | 91 | 2.0 | 4 | 5 |
| | | | P-10 | | | | | | |
| Ex. 10 | 27 | 1/2 | WIP | 70 | 89 | 92 | 2.1 | 4 | 4 |
| | | | P-12 | | | | | | |
| Ex. 11 | 27 | 1/2 | WIP | 65 | 91 | 91 | 2.0 | 4 | 4 |
| | | | P-18 | | | | | | |
| Ex. 12 | 27 | 1/2 | WIP | 64 | 89 | 91 | 2.1 | 4 | 4 |
| | | | P-20 | | | | | | |
| Comp. | 52 | 1/2 | WIP | 67 | 86 | 85 | 5.6 | 2 | 2 |
| Ex. 1 | | | P-26 | | | | | | |
| Comp. | 110 | 1/2 | WIP | 66 | 84 | 84 | 7.8 | 1 | 2 |
| Ex. 2 | | | P-26 | | | | | | |
| Comp. | 110 | 1/5 | WIP | 4,500 | 85 | 85 | 7.6 | 3 | 2 |
| Ex. 3 | | | P-26 | | | | | | |
| Comp. | 110 | 1/2 | WSP | 73 | 84 | 82 | 7.8 | 1 | 2 |
| Ex. 4 | | | (PVP) | | | | | | |
| Comp. | 27 | 1/2 | WSP | 56 | 90 | 88 | 2.1 | 2 | 3 |
| Ex. 5 | | | (PVP) | | | | | | |
| Comp. | 27 | 1/5 | WSP | 83 | 90 | 87 | 2.1 | 2 | 3 |
| Ex. 6 | | | (PVP) | | | | | | |
| Comp. | 27 | 1/2 | PIB | 2,450 | 86 | 86 | 3.1 | 3 | 2 |
| Ex. 7 | | | | | | | | | |
| Comp. | 27 | 1/2 | * | >10⁷ | 88 | 89 | 2.4 | 3 | 1 |
| Ex. 8 | | | | | | | | | |

In Table 2, in the column of “Type of binder,” “WIP” means water-insoluble polymer, “WSP” means water-soluble polymer, “PIB” means polyisobutylene and “*” means the cured product of the photocurable composition.

As is clear from Table 2, the samples of Examples 1 to 12, containing in combination very thin metal nanowires and the above specific water-insoluble polymer, were excellent in all of conductivity, transmittance at 450 nm, transmittance at 800 nm, haze, durability and flexibility. In contrast, the samples of Comparative Examples 1 to 8 were poor in at least one of conductivity, transmittances, haze, durability and flexibility. In particular, from the results of Comparative Example 1, when the average minor axis diameter of the metal nanowires was 52 nm, the sample was increased in haze and also degraded in durability and flexibility.

### (Production of Touch Panel)

The transparent conductors of Examples 1 to 12 exhibited high transmittance with respect to light having a long wavelength. Thus, by virtue of improvement in transmittance, it was found that touch panels produced from the transparent conductors of Examples 1 to 12 were excellent in visibility. In addition, by virtue of improvement in conductivity, it was also found that touch panels produced therefrom were excellent in response to input of characters, etc. or screen touch with at least one of a bare hand, a hand wearing a glove and a pointing tool. Notably, the touch panel encompasses so-called touch sensors and touch pads.

Also, the touch panels were produced by a known method described in, for example, “Latest Touch Panel Technology (Saishin Touch Panel Gijutsu)” (published on Jul. 6, 2009 from Techno Times Co.), “Development and Technology of Touch Panel (Touch Panel no Gijustu to Kaihatsu),” supervised by Yuji Mitani, published from CMC (2004, 12), FPD International 2009 Forum T-11 Lecture Text Book, Cypress Semiconductor Corporation Application Note AN2292.

### (Production of Integrated Solar Cell)<

### Production Example 1

### Production of Amorphous Solar Cell (Super Straight Type)

The conductive composition 1 of Example 1 was applied onto a glass substrate, followed by drying at 25° C. and 55% RH, to thereby form transparent conductor 1. The amount of the silver contained in the transparent conductor 1 was measured with an X-ray fluorescence spectrometer (product of SII Inc., SEA1100) and was found to be 0.05 g/m². Through plasma chemical vapor deposition, a p-type amorphous silicon layer having a thickness of 15 nm was formed on the transparent conductor 1, an i-type amorphous silicon layer having a thickness of 350 nm was formed on the p-type amorphous silicon layer, an n-type amorphous silicon layer having a thickness of 30 nm was formed on the i-type amorphous silicon layer, a gallium-doped zinc oxide layer having a thickness of 20 nm was formed on the n-type amorphous silicon layer as a backside reflecting electrode, and a silver layer having a thickness of 200 nm was formed on the gallium-doped zinc oxide layer, to thereby produce photoelectric conversion element 1A.

### Production Examples 2 to 7

### Production of Amorphous Solar Cell (Super Straight Type)

The procedure of Production Example 1 was repeated, except that the transparent conductor 1 was changed to each of the transparent conductors 2 and 9 to 13, to thereby produce photoelectric conversion elements 2A to 7A.

### Production Example 8

### Production of CIGS Solar Cell (Substrate Type)

A molybdenum electrode having a thickness of about 500 nm was formed on a glass substrate through DC magnetron sputtering. A 2.5 μm-thick thin film of Cu(In_{0.6}Ga_{0.4})Se₂ (a chalcopyrite semiconductor material) was formed on the electrode through vacuum vapor deposition. A cadmium sulfide thin film having a thickness of 50 nm was formed on the Cu(In_{0.6}Ga_{0.4})Se₂ thin film through solution deposition. The conductive composition 1 of Example 1 was applied onto the cadmium sulfide thin film, followed by drying at 25° C. and 55% RH, to thereby form transparent conductor 1. The amount of the silver contained in the transparent conductor 1 was measured with an X-ray fluorescence spectrometer (product of SII Inc., SEA1100) and was found to be 0.05 g/m². A boron-doped zinc oxide thin film (transparent conductive layer) having a thickness of 100 nm was formed on the transparent conductor 1 through DC magnetron sputtering, to thereby produce photoelectric conversion element 1B.

### Production Examples 9 to 14

### Production of CIGS Solar Cell (Substrate Type)

The procedure of Production Example 8 was repeated, except that the transparent conductor 1 was changed to each of the transparent conductors 2 and 9 to 13, to thereby produce photoelectric conversion elements 2B to 7B.

### (Evaluation of Solar Cell Performance (Conversion Efficiency))

Each of the solar cells was irradiated with artificial sunlight of AM1.5 at 100 mW/cm² to evaluate the solar cell performance (conversion efficiency). The results of the amorphous solar cells are shown in Table 3 and the results of the CIGS solar cells are shown in Table 4.

TABLE 3

| | | | Conversion |
|---|---|---|---|
| | | Transparent conductor | efficiency |
| | | used | (%) |
| Production | Photoelectric | Example 1 | 11 |
| Example 1 | conversion element 1A | | |
| Production | Photoelectric | Example 2 | 10 |
| Example 2 | conversion element 2A | | |
| Production | Photoelectric | Comparative | 8 |
| Example 3 | conversion element 3A | Example 2 | |
| Production | Photoelectric | Comparative | 7 |
| Example 4 | conversion element 4A | Example 3 | |
| Production | Photoelectric | Comparative | 8 |
| Example 5 | conversion element 5A | Example 4 | |
| Production | Photoelectric | Comparative | 8 |
| Example 6 | conversion element 6A | Example 5 | |
| Production | Photoelectric | Comparative | 8 |
| Example 7 | conversion element 7A | Example 6 | |

TABLE 4

| | | Transparent | Conversion |
|---|---|---|---|
| | | conductor used | efficiency (%) |
| Production | Photoelectric | Example 1 | 12 |
| Example 8 | conversion element 1B | | |
| Production | Photoelectric | Example 2 | 11 |
| Example 9 | conversion element 2B | | |
| Production | Photoelectric | Comparative | 9 |
| Example 10 | conversion element 3B | Example 2 | |
| Production | Photoelectric | Comparative | 8 |
| Example 11 | conversion element 4B | Example 3 | |
| Production | Photoelectric | Comparative | 9 |
| Example 12 | conversion element 5B | Example 4 | |
| Production | Photoelectric | Comparative | 9 |
| Example 13 | conversion element 6B | Example 5 | |
| Production | Photoelectric | Comparative | 9 |
| Example 14 | conversion element 7B | Example 6 | |

As is clear from Tables 3 and 4, it was found that the solar cells containing the transparent conductors of Examples 1 and 2 were much higher in conversion efficiency than those containing the transparent conductors of Comparative Examples 2 to 6. This is likely because the transparent conductor produced using the water-insoluble polymer was decreased in water content and thus improved in transmittance to lights in the long wavelength region.

The conductive composition of the present invention attains excellent conductivity, transmittance, haze, durability and flexibility and thus, can be used for touch panel, charge prevention for display, electromagnetic shield, organic or inorganic EL display electrode, electronic paper, flexible display electrode, flexible display antistatic film, solar cell, and other various devices.

What is claimed is:

1. A conductive composition comprising:
metal nanowires having an average minor axis diameter of 5 nm to 45 nm, and
a water-insoluble polymer containing at least one ethylenically unsaturated group selected from an acryloyl group and a methacryloyl group.

2. The conductive composition according to claim 1, wherein the water-insoluble polymer contains a main chain and a side chain linked with the main chain, and the side chain contains at least one ethylenically unsaturated bond.

3. The conductive composition according to claim 1, wherein the water-insoluble polymer contains a structure represented by the following General Formula (I): 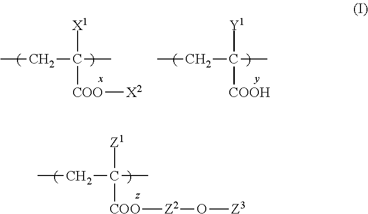
where X¹, Y¹ and Z¹ each independently represent a hydrogen atom or a methyl group, X² represents an organic group having a branched structure or an alicyclic structure, Z² represents a single bond or a divalent organic group, Z³ represents an acryloyl group or a methacryloyl group, and x, y or z denotes a molar ratio of a repeating unit indicated by x, y or z and is a numerical value greater than 0 but smaller than 100, provided that a sum of x, y and z is 100.

4. The conductive composition according to claim 3, wherein X² is an isopropyl group, a t-butyl group, a cyclohexyl group, a dicyclotrimethyl group or a dicyclopentanyl group, and Z² is a 2-hydroxy-1,3-propylene group or a 2-hydroxy-1,4-cyclohexylene group.

5. The conductive composition according to claim 3, wherein x is 10 to 75, y is 5 to 70 and z is 10 to 70.

6. The conductive composition according to claim 1, wherein the water-insoluble polymer has a weight average molecular weight of 10,000 to 100,000.

7. The conductive composition according to claim 1, wherein the metal nanowires have an average major axis diameter of 1 μm to 40 μm.

8. The conductive composition according to claim 1, wherein a ratio of A/B is 0.1 to 5 where A denotes a mass of the metal nanowires and B denotes a mass of the water-insoluble polymer.

9. The conductive composition according to claim 1, further comprising a dispersing agent for dispersing the metal nanowires.

10. The conductive composition according to claim 9, wherein the dispersing agent is contained in an amount of 0.1 parts by mass to 50 parts by mass per 100 parts by mass of the water-insoluble polymer.

11. A transparent conductor comprising:
a conductive layer,
wherein the conductive layer comprises a conductive composition, and
wherein the conductive composition comprises metal nanowires having an average minor axis diameter of 5 nm to 45 nm and a water-insoluble polymer containing at least one ethylenically unsaturated group selected from an acryloyl group and a methacryloyl group.

12. A touch panel comprising:
a transparent conductor,
wherein the transparent conductor comprises a conductive layer,
wherein the conductive layer comprises a conductive composition, and
wherein the conductive composition comprises metal nanowires having an average minor axis diameter of 5 nm to 45 nm and a water-insoluble polymer containing at least one ethylenically unsaturated group selected from an acryloyl group and a methacryloyl group.
